(19) United States
(12) Patent Application Publication
(10) Pub. No.: US 2010/0332325 A1
(43) Pub. Date: Dec. 30, 2010

(54) MENU SEARCH

(76) Inventor: Bjorn Holte, Oslo (NO)

Correspondence Address: DORSEY & WHITNEY LLP;INTELLECTUAL PROPERTY DEPARTMENT, 250 PARK AVENUE, NEW YORK, NY, 10177, US

(21) Appl. No.: 12/739,945

(22) PCT Filed: Oct. 24, 2008
(86) PCT No.: PCT/NO08/00377

§ 371 Date: Sep. 1, 2010

Related U.S. Application Data
(60) Provisional application No. 60/984,770, filed on Nov. 2, 2007.

(30) Foreign Application Priority Data
Oct. 26, 2007 (NO) 20075435

(51) Int. Cl. G06Q 30/00; G06F 17/30

(52) U.S. Cl. 705/14.54; 707/769; 707/E17.014

(57) ABSTRACT

Exemplary embodiments of system, computer-accessible medium, method and procedure are provided herein for performing a search in a hierarchical structure of a plurality of information items. For example, an exemplary method according to the present disclosure can include, e.g., receiving user input representing a search term, and performing a search for information items corresponding to the search term in a file. The file can be residing and/or received from a server, and configured to describe a hierarchical structure of the information items. The information items can relate to web pages, and the hierarchical structure can relate to a link structure between the web pages. The exemplary procedure can further include displaying the information items in a menu-based and/or a hierarchical presentation. The displayed information items can be included in results of the search, and the presentation of the hierarchical structure of information items can include a parent item, for example.

### CROSS-REFERENCE TO RELATED APPLICATION(S)

This application is a national stage application of PCT Application No. PCT/NO2008/000377 which was filed on Oct. 24, 2008 and published on Apr. 30, 2009 as International Publication No. WO 2009/054731 (the “International Application”). This application claims priority from the International Application pursuant to 35 U.S.C. §365, and from Norweign Patent Application No. 20075435 filed on Oct. 26, 2007, under 35 U.S.C. §119. The present application also relates to and claims priority from U.S. Provisional Patent Application Ser. No. 60/984,770 filed on Nov. 2, 2007. The disclosures of the above-referenced applications are incorporated herein by reference in their entities.

### FIELD OF THE DISCLOSURE

The present disclosure relates to a system, method, procedure, software arrangement and computer-accessible medium which can provide improved navigation of web content within a web site or other types of hierarchically structured information. The present disclosure further relates to a system, method, procedure software arrangement and computer-accessible medium for providing searchable navigational menus that facilitate access to specific web pages and specific content on web pages located within a web site, without the need to load or browse intermediate or top-level pages in a hierarchy of the site.

### BACKGROUND INFORMATION

When accessing large websites or large quantity of information, search engines are the most common way to find what you are looking for. The problem with search is that the information is shown in a result list where you don't know where in the archive it is placed. There are often several files with the same content, making it difficult to determine which document is the most correct or valuable for the specific search.

This inventor's patent application U.S. Ser. No. 11/364,393, which is hereby incorporated by reference in its entirety, introduced the possibility of navigating a whole website with standard drop down menus. According to the method of that application, a hierarchical menu is provided, enabling a user to start navigating a category and drill down several levels in order to find the desired information on a web page somewhere on the site.

While such a system provides advantages over the traditional search engine approach, a user will still experience a disadvantage when the menus contain a large amount of information and the user can need to explore several categories and navigate several levels down in order to locate the information.

The Internet provides users access to a multitude of web sites. These web sites can be made up of web pages, which can be linked together using a hypertext markup language (“HTML”) code. There is currently no standard procedure for navigating through a web site to pages located at an intermediate or lower level. Different web sites can have different link structures and interfaces. This can make navigating different web sites much more complex and demanding than necessary.

Some of the existing approaches to providing or facilitating web site navigation can suffer from one or more of the following disadvantages:

a) Locating a navigation menu on current web sites can be a time-consuming process. The placement of such a menu can differ from one web site to another. Current web sites can have the top-level menu links located at or near the top of a web page, or in a column on the left or right side of a page. Certain web sites can also have unique or non-standard navigation aids or menus.

b) Locating specific menu content on current web sites can be a time-consuming process. The placement of, for example, the contact information within a link structure is not standardized among different web sites, which can require the user to locate it for each individual site.

c) The layout of menus on a given web site can make navigation a time-consuming process. Menus for various web pages can differ in design, colors, fonts, graphics, symbols, pictures and/or text size.

d) Navigating to a web page that is several levels deep within a web site can be a time-consuming process. A web site can include a plurality of pages linked together in a hierarchic structure that can contain several levels. To reach the web page that is several levels deep in the site hierarchy, the user can need to browse the pages on the levels in-between to access the specific web page.

e) To navigate a web site, each web page can have to be loaded into the browser. It may not be possible to navigate down to any specific page within a web site directly, or to only load a desired page without loading or browsing intervening pages.

f) In conventional site navigation, the total link structure often may not be available from all web pages. Many web sites can require that the navigation begins from the first page of the web site. When browsing a page at a sublevel, a user can be required to return to the first page and then navigate to a different category, instead of having all possible category links available from every page within the site.

g) It may not be possible to select the language of the menu labels for a web site.

h) Creating a navigational menu on the web site can require an implementation of a specific link structure on each web site, either by manually providing such information or by using software or web publishing systems to create it. The link structure for each web site can also have to be implemented on the specific web site.

i) Browsing web content on small-screen devices, such as personal digital assistants (“PDAs”) and mobile phones can be difficult because it can be hard to both view and select specific items on the available menus.

j) Browsing the web content on a television-based system can be difficult because a movement of the cursor on such systems via a remote control can be inaccurate.

Thus, there can be a clear need to provide navigational aids and menus for existing and new web sites, which can improve access to the specific content and web pages within these sites.

### SUMMARY OF EXEMPLARY EMBODIMENTS OF THE DISCLOSURE

Accordingly there can be a need for a method of providing a user with a more efficient way of locating and accessing information that is provided on a website. The present disclosure provides a method, a system and a computer program product for searching a system of drop down menus or a similarly arranged structure of references to content of a web site. According to some embodiments of the disclosure, the menu search is a search that provides a result that can be displayed in a hierarchal menu structure.

For example, a search can be initiated by entering characters (e.g. a word, a phrase, and/or an identification sequence for the desired information) in a search field, and a list with relevant words can appear, e.g. in a window adjacent to the search field. Such results can include, e.g., one or more of the characters entered, words related to the characters, and/or other words located in proximity to the search results within the web site. The user can then scroll with arrow keys or use the mouse to select relevant search results. According to certain aspects of the disclosure, the displayed search results can be menu elements such that when the user clicks on, or otherwise selects one of them, a menu tree can be opened up and display where in the menu structure the selected hit can be found.

If a user searches for FIFA and one menu containing this relevant word is located under the category Football, which itself is a subcategory under the sports menu, both the sports and football menu could appear at the same time. This can show the user what parent category the selected search result belongs under, and also the group and siblings if the menu goes deeper. An opened menu based on these menu elements are displayed in FIG. 20B.

The present disclosure provides methods, systems, software arrangements, and computer-accessible media for searching hierarchal menus which can enhance and simplify the navigation of web sites or other hierarchically organized content.

For example, exemplary embodiments of the present disclosure can include one or more of the following:

a) provide a standard location of searching menus for browsing web sites;

b) provide specific searchable menu content, such as contact information, in a standard location and layout to facilitate the accessing of the content on a web site;

a) provide options to users to vary characteristics of the text used to display menu items, including size, font, style, color, and the like;

c) provide an ability to navigate to the web pages within the hierarchy of the web site, without requiring loading or browsing of intermediate web pages or sub-menus;

d) permit the navigation directly to a specific page of the web site, and load only the desired page without loading any other page, even if the desired page has not been previously loaded or browsed by the user;

e) permit access to a total or partial searchable navigational menu structure of the web site that is available from any web page within the web site;

f) permit a selection and/or a change of the language of the navigational menu labels of the web site;

g) generate and use of web site navigational menus which do not have to be implemented on the web site or the web site server itself;

h) provide a standardized menu system for the improved navigation of the web content accessed via small-screen devices such as PDAs and mobile phones;

i) provide a standardized searchable menu system for the improved navigation of the web content accessed via a TV-based system;

j) provide a standardized menu system that can be limited to a preselected number of top-level menu items, total number of menu items and/or number of menu levels; and

k) provide storage of data related to the navigational menus on a local memory cache for faster access when revisiting a web site.

These and other objects, features and advantages of the present disclosure will become apparent upon reading the following detailed description of embodiments of the disclosure, when taken in conjunction with the appended claims.

### BRIEF DESCRIPTION OF THE DRAWINGS

For a more complete understanding of the present disclosure and its advantages, reference is now made to the following detailed description taken in conjunction with the accompanying drawings showing illustrative embodiments of the disclosure, in which:

FIG. 1 is a block diagram of an exemplary embodiment of a system according to the present disclosure;

FIG. 2 is a block diagram of a second exemplary embodiment of the system according to the present disclosure;

FIG. 3A is a flow diagram of an exemplary embodiment of a method according to the present disclosure;

FIG. 3B is a flow diagram of a second exemplary embodiment of the method according to the present disclosure;

FIG. 4 is a flow diagram of a third exemplary embodiment of the method according to the present disclosure;

FIG. 5A is a flow diagram of a fourth exemplary embodiment of the method according to the present disclosure;

FIG. 5B is a flow diagram of a fifth exemplary embodiment of the method according to the present disclosure;

FIG. 5C is a flow diagram of a sixth exemplary embodiment of the method according to the present disclosure;

FIG. 5D is a flow diagram of a seventh exemplary embodiment of the method according to the present disclosure;

FIG. 5E is a flow diagram of an eighth exemplary embodiment of the method according to the present disclosure;

FIG. 5F is a flow diagram of a ninth exemplary embodiment of the method according to the present disclosure;

FIG. 6A is a hierarchal diagram of an exemplary link structure of a web site;

FIG. 6B is a hierarchal diagram of an exemplary filtered link structure of a web site;

FIG. 7A is an exemplary listing of source code for a first exemplary web page of the web site, provided with the associated web page;

FIG. 7B is an exemplary listing of source code for a second exemplary web page of the web site, provided with the associated web page;

FIG. 7C is an exemplary listing of source code for a third exemplary web page of the web site, provided with the associated web page;

FIG. 7D is an exemplary listing of source code for a fourth exemplary web page of the web site, provided with the associated web page;

FIG. 8A is an illustration of an exemplary menu structure corresponding to the exemplary web pages shown in FIG. 7A-7D;

FIG. 8B is an illustration of the menu structure of FIG. 8A with particular elements being highlighted;

FIG. 9A is an illustration of an exemplary main menu bar for an exemplary web page;

FIG. 9B is an illustration of exemplary submenus associated with the main menu bar shown in FIG. 9A;

FIG. 10A is a screenshot of an exemplary web page showing the use of hierarchal navigational menus that can be used with the method, system, software arrangement and computer-accessible medium in accordance with an exemplary embodiment of the present disclosure, and

FIG. 10B is a screenshot of a second exemplary web page showing further use of hierarchal navigational menus that can be used with the method, system, software arrangement and computer-accessible medium in accordance with an exemplary embodiment of the present disclosure;

FIG. 11 is a flow diagram of a tenth exemplary embodiment of the method according to the present disclosure;

FIG. 12 is a flow diagram of an eleventh exemplary embodiment of the method according to the present disclosure;

FIG. 13 is a flow diagram of a twelfth exemplary embodiment of the method according to the present disclosure;

FIG. 14 is a flow diagram of a thirteenth exemplary embodiment of the method according to the present disclosure;

FIG. 15A is a representation of a first exemplary web page of an exemplary web site, shown together with a listing of associated source code, and

FIG. 15B is a representation of a second exemplary web page of an exemplary web site, shown together with a listing of associated source code;

FIG. 16A is an illustration of an exemplary menu structure corresponding to processed page links from the exemplary web pages shown in FIGS. 15A and 15B,

FIG. 16B is an illustration of a further menu structure corresponding to the processed page links from the exemplary web pages shown in FIGS. 15A and 15B, and

FIG. 16C is an illustration of a still further exemplary menu structure corresponding to the exemplary web page shown in FIG. 15A;

FIG. 17A is an illustration of an exemplary web page content corresponding to the exemplary web page shown in FIG. 15A, and

FIG. 17B is an illustration of an exemplary web page content corresponding to the exemplary web page shown in FIG. 15B;

FIG. 18 A is a flow diagram of an exemplary embodiment of a method according to the present disclosure, and

FIG. 18 B is a flow diagram of an exemplary embodiment of a method according to the present disclosure;

FIG. 19A is an illustration of the menu search field,

FIG. 19B is an illustration of the menu search field with alternatives displayed,

FIG. 19C is an illustration of the menu search field where an alternative is selected, and

FIG. 19D is an illustration of the menu search field where an alternative is selected and the menu is opened accordingly;

FIG. 20A is a screenshot of an exemplary of menu search, and

FIG. 20B is a screenshot of an exemplary menu search activated.

### DETAILED DESCRIPTION OF EXEMPLARY EMBODIMENTS OF DISCLOSURE

Exemplary embodiments of the present disclosure can provide system, method and computer-accessible medium which can allow searching for content in a web site or in a database. Results of the search can also display or otherwise indicate at least a portion of a hierarchical structure of the web site or database, and further display or indicate a location of a particular search result within the hierarchical structure.

For example, an arrangement of navigational menus can be provided. Navigational information describing such navigational menus can be stored in memory or another storage device and/or displayed on a client (e.g., personal computer, computer terminal, cell phone, personal digital assistant, etc.). Such navigational information can be stored into client memory such that a search can be performed directly in the navigational information.

A search performed in accordance with exemplary embodiments of the present disclosure can provide a plurality of search results. The search results can be provided as menu items in a results menu hierarchy. For example, a selection of a particular search result can open or display a corresponding menu item and some or all higher-level “parents” of the menu item.

In certain exemplary embodiments of the present disclosure, information describing the navigational menus can be indexed, e.g., by generating a list of all menu labels within the navigational menus together with an identifier which can identify a location or position of the menu label within the navigational menu hierarchy. Such indexing can provide a faster search procedure, especially if there are numerous menu labels (e.g., a large arrangement of navigational menus) and/or if storage of the entire arrangement of navigational menus in local memory is not possible.

In further exemplary embodiments of the present disclosure, information describing the navigational menus and/or information which can be used to generate and access the search field can be stored as data associated with a particular web page, and further can be stored in a memory/storage arrangement or server which can be local to the web page or web site containing the web page. Thus, a search field can be provided using such information, which can be stored with, or otherwise associated with, web page information used to generate the web page. For example, the search field can be provided directly (e.g., “embedded”) within a web page using a software utility such as, e.g., AJAX.

The exemplary menu search field and exemplary menu search procedures described herein can also be provided in a form of a plug-in which can provide, e.g., a tool bar in a browser, a web application embedded in a web page, and/or a direct communication to an application or a computer operating system.

The exemplary embodiments of the system, method, software arrangement and computer-accessible medium according to the present disclosure, referred to herein as “navigation menu” can be implemented using the following exemplary techniques, procedures and arrangements.

According to certain exemplary embodiments of the present disclosure, a system, method, software arrangement and computer-accessible medium can be provided for generating a drop-down menu interface for existing web sites. This exemplary menu interface can be hierarchal. The exemplary embodiment of the navigation menu described herein can detect all or part of the web page hierarchy and structure of the particular web site, and can convert this into menu data. The menu data can be stored in a central database and accessed or made available when requested from a client computer. The client computer and web browser operating thereon can convert this menu data to a dropdown menu interface, thus enabling a user to navigate the web site with a menu.

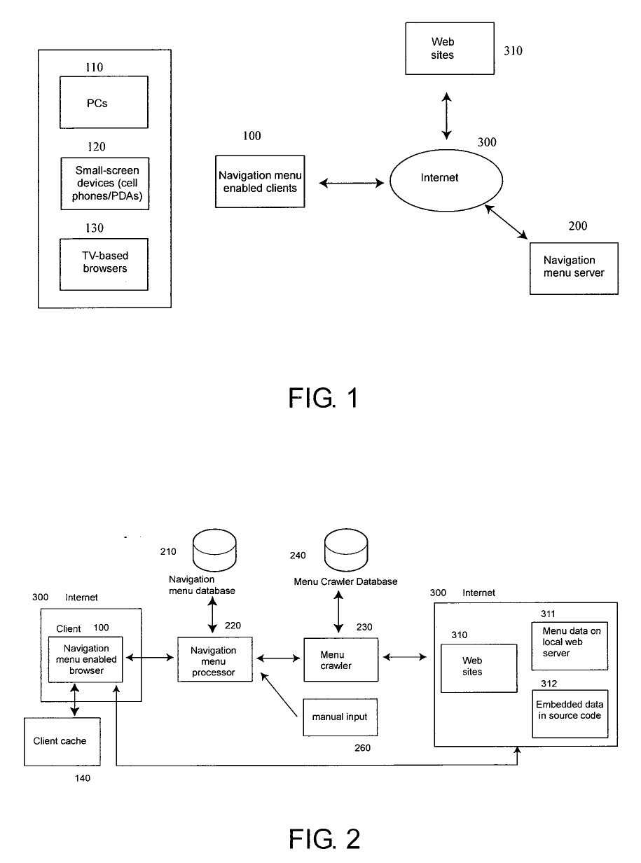

FIG. 1 shows a block diagram of one exemplary embodiment of a system according to the present disclosure that can be configured to access Internet content. In this embodiment, an exemplary navigation menu-enabled client (“client”) 100 can be configured to communicate with web sites 310 (which can be located on various web servers) through a navigation menu server (“server”) 200 via the Internet 300. The client 100 can include, but is not limited to, a personal computer (“PC”) 110, a personal digital assistant (“PDA”) 120, a television-based web browser (“TV browser”) 130, etc.

The client 100 can provide a uniform resource locator (“URL”) or other information capable of identifying the web site 310 (which the client 100 can be browsing or accessing) to the server 200. The server 200 can respond by providing menu data for the requested web site to the client 100 if it is available on the server 200. The client 100 can then use the menu data to generate and display a navigational menu, and can enable the user utilizing the client to navigate the content of the web site 310 by selecting menu items within the navigational menu. The exemplary embodiment of the system according to the present disclosure can also be configured such that both the client 100 and the server 200 can be executed on the same computer.

According to some embodiments, the client 100 can be a device including a processor, a memory whereupon is installed a set of instructions, a user input interface and a display, communicatively connected by a system bus. The client can include a network interface enabling communication with the server 200 and the web site 310 over the Internet 300.

Another exemplary embodiment of the system according to the present disclosure is shown as a block diagram in FIG. 2. In this exemplary embodiment, the system comprises four modules; e.g., the client 100, the navigation menu database 210, the navigation menu processor (“processor”) 220, and the navigation menu crawler (“crawler”) 230, which can be in communication with a crawler database 240.

The crawler 230 can comprise a standard program or software arrangement stored in memory or another storage arrangement (e.g., hard drive, flash drive, CD-ROM, etc.) which, when run, can configure an associated processor, which can be the navigation menu processor 220, to access and/or read Internet- or web-based content 300 by following links on web pages that it accesses. The crawler 230 can be programmed or, alternatively, obtained as an existing software package.

The crawler 230 can configure the processor 220 or, alternatively, a different processor, to “crawl” a web site (e.g., browse or access web pages, optionally without direct supervision or control by a user or a system administrator) for links located on web pages within the site, and detect the link structure of the web site. The link structure of a web site can relate to the links associated with web pages within the web site, which can comprise URLs that identify other web pages within the web site, and the interrelated structure and/or hierarchy of these links.

The crawler 230 can also detect menu data that can optionally be located on a local web server 311 and/or embedded in source code 312 of the web page. The menu data provided on or accessed by a local web server can be placed in a file at root level, e.g., similarly to the way that conventional robot.txt files can be associated with web pages and provided for search engine crawlers. The file containing such menu data can be assigned a predetermined name that can be recognized by the crawler 230 such as, e.g., navigation_menu.txt. Menu data optionally embedded in the source code of the web site can be provided, e.g., in the form of individual links or as a menu structure of the entire web site, and can be included in the first or main page of the web site. The menu data can be identified by a predetermined tag which can be recognized by the crawler 230 such as, e.g., <navigation menu>.

The “link rel” code, which can be implemented by some existing web sites, can represent an example of this type of embedded data coding. However, <link rel> tags generally provide one level of menus, and it is possible that they may not include hierarchal information that can permit generation of a hierarchal menu scheme.

The URL of the web site that the crawler 230 accesses can be located in a crawler database 240. The crawler database 240 can contain a record for each URL accessed by the crawler 230, where the record can include information such as, e.g., a date that the site was most recently accessed or crawled, which can be used by the crawler 220 to keep the crawler database 240 updated, and which can further reduce or eliminate dead and/or duplicate links.

For example, the crawler 230 can communicate via the Internet 300 to crawl or access the web site 310, send the link structure obtained therein to the processor 220, and then receive additional URLs from processor 220 to crawl. The URLs and corresponding link structures thus obtained can be stored in the crawler database 240.

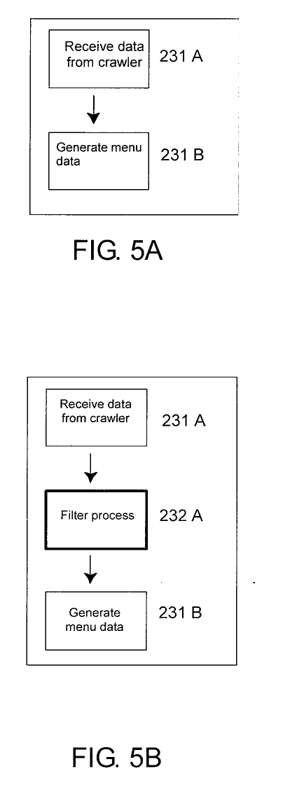

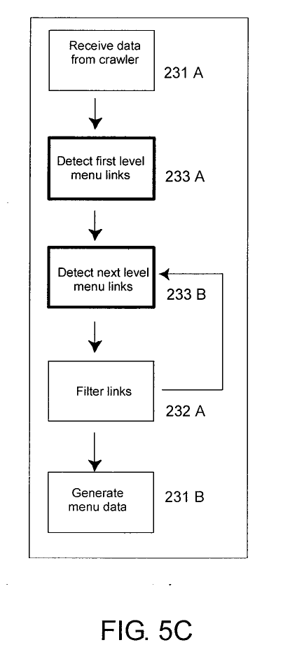

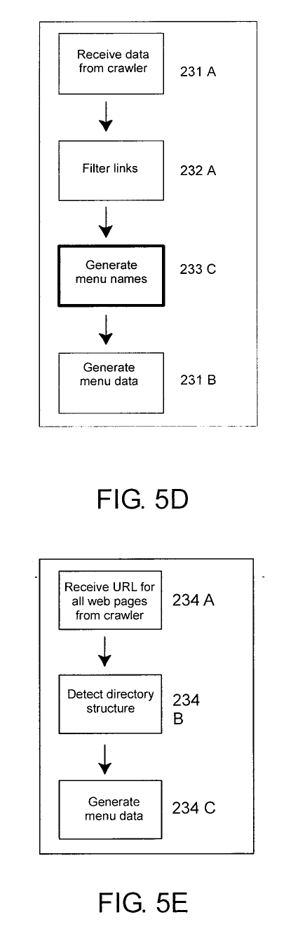

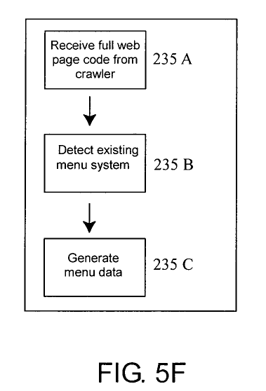

The processor 220 can be configured to process information obtained from the crawler 230, and utilize that information to generate the menu data. The menu data can then be stored in the navigation menu database 210. Optionally, the crawler database 240 and the navigation menu database 210 can be stored on the same server. Exemplary flow diagrams of exemplary process and methods for generating the menu data are shown in FIGS. 5A-5E, which is described below in further detail.

In certain exemplary embodiments of the method according to the present disclosure, the processor 220 can also handle requests for receipt and/or generation of the menu data from the client 100 and can respond to these requests by providing the menu data obtained from the navigation menu database 210. When there is no menu data available for the requested web site on the navigation menu database 210, a message or instruction can be transmitted to the crawler 230 to crawl or access the web site to obtain the link structure or other information from the web site, which can be used to generate the menu data. In certain exemplary embodiments of the present disclosure, the processor 220 can also be configured to receive preprocessed menu data either directly or indirectly via a manual input 260.

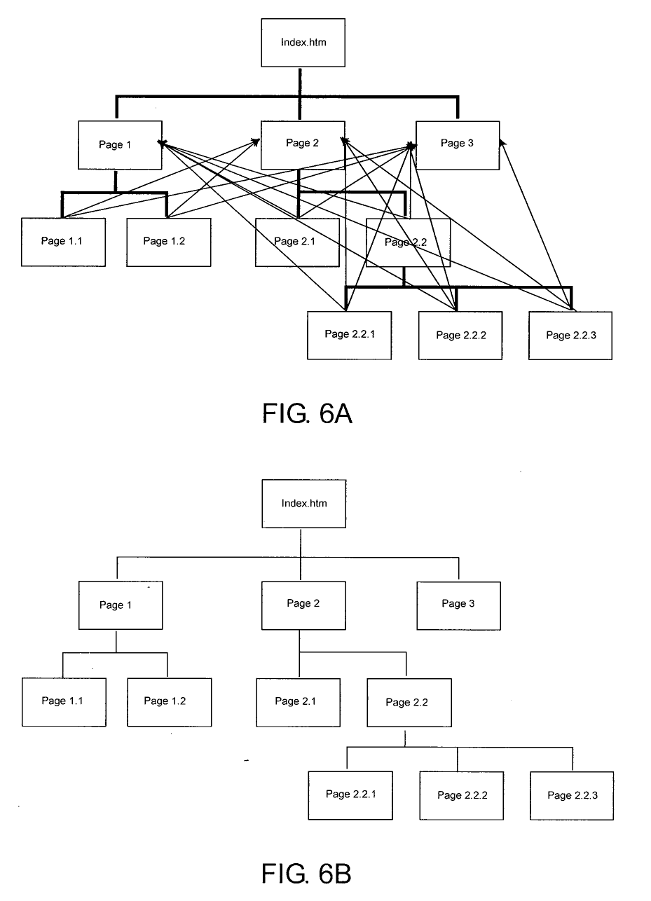

The menu data can comprise, but is not limited to, the menu structure of the web site. The menu data can comprise individual menu components, and it can be presented in several ways. For example, each menu component within the menu data can have a specific name or label to identify it. A menu component that is configured to lead or direct to the web page or location within the web site can further comprise an URL or a link. The menu data can further comprise tagging or listing information that is capable of defining a hierarchal structure, which can be converted to a hierarchal menu that can be displayed or accessed by the client 100. A listing of exemplary menu data that can be generated for the exemplary web site link structure shown in FIGS. 6A and 6B can be as follows:

<tb><sep><navigation menu>
<tb><sep><menu name=“Menu 1” url=“page1.htm”>
<tb><sep><link url=“page11.htm”>Menu 1.1</link>
<tb><sep><link url=“page12.htm”>Menu 1.2</link>
<tb><sep></menu>
<tb><sep><menu name=“Menu 2” url=“page2.htm”>
<tb><sep><link url=“page21.htm”>Menu 2.1</link>
<tb><sep><menu name=“Menu 2.2” url=“page22.htm”>
<tb><sep><link url=“page221.htm”>Menu 2.2.1</link>
<tb><sep><link url=“page222.htm”>Menu 2.2.2</link>
<tb><sep><link url=“page223.htm”>Menu 2.2.3</link>
<tb><sep></menu>
<tb><sep></menu>
<tb><sep><menu name=“Menu 3” url=“page3.htm”>
<tb><sep></menu>
<tb><sep></“navigation menu”>

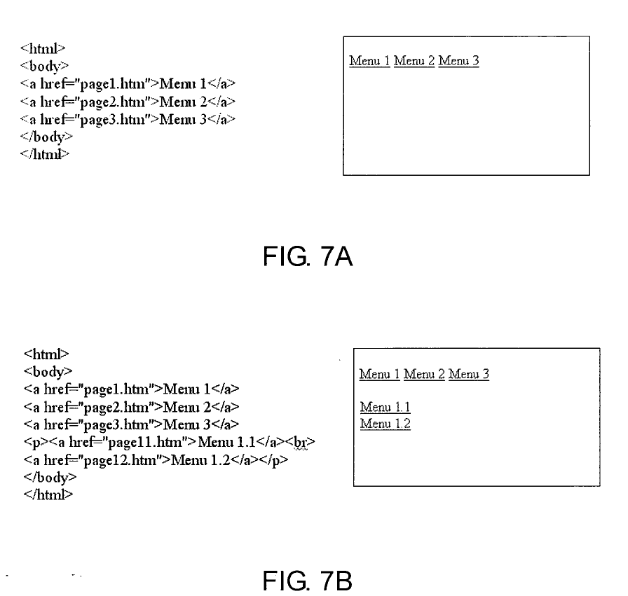

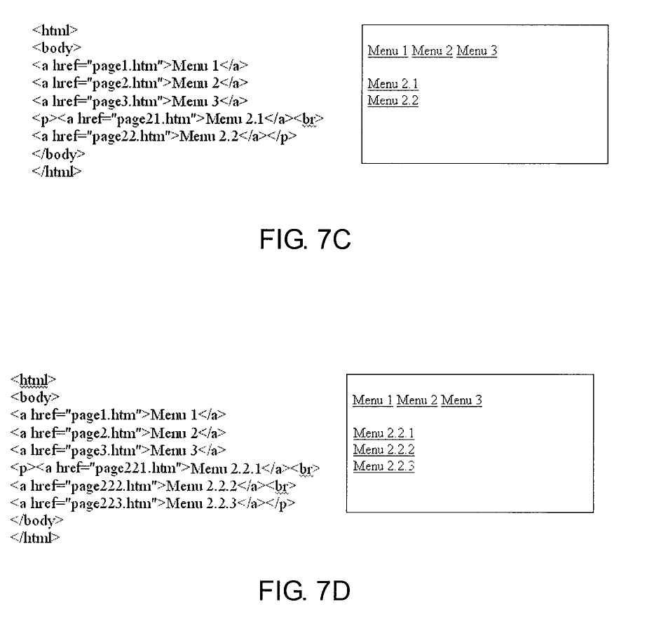

Exemplary HTML code describing the web site, together with the appearance of corresponding web pages generated by the code, is shown in FIGS. 7A-7D.

The navigation menu database 210 can be used for storing the menu data. The navigation menu database 210 can store the data as plain text and/or utilize conventional database software to make the storage and handling of the menu data more efficient. The menu data stored on the navigation menu database 210 can be provided and/or accessed by the processor 220.

The client 100 can be a web browser that is capable of requesting and receiving the menu data received from the processor 220. The client 100 can include, but is not limited to, a browser application accessed via a personal computer, a TV-based browser that can display web content on a television, or a device comprising a software application and a display that can be configured to access and/or browse web content, such as a mobile phone or a PDA. Conventional browser software applications can include Microsoft's Internet Explorer, Netscape, Firefox, Opera or the like.

Existing browsers or other software applications can be enabled to operate or integrate with the exemplary embodiments of the navigation menu system of the present disclosure by implementing native support for the navigation menu within the browser software code with the use of client-side scripting, and/or by the use of a software component running separately on the client 100. The software component can include a bar which can be displayed at the top of a browser window, such as the search bar provided by Google or Yahoo! Implementing native support can mean that the exemplary embodiments of the navigation menu system can be integrated as parts of the browser's software application. The software component that can be configured to display and use the menu data can be programmed, for example, in C++, Java, Visual Basic, Delphi, NET, etc. The choice of a computer language to use can depend on the browser and the operating system. For example, it may only be possible to use .NET to implement the exemplary navigation menu system of the present disclosure into the Microsoft Explorer.

To enhance performance, the client 100 can locally store the menu data associated with frequently accessed web sites. The client 100 can search a cache 140 for the menu data and retrieve such data, if present, rather than sending a request to retrieve web site information by crawling the web site, and generate the menu data. The cached menu data can also have a date or other marker associated with it, which can be compared to data associated with the web site itself to determine if the cached data is current or outdated. If the cached data is determined to be outdated, e.g., because the web site has been modified since the cached data was obtained, then current menu data can be obtained by crawling or accessing the web site again as described above, and such new menu data can be stored on the cache 140.

The client 100 can optionally identify and use the menu data 311 that can be stored on a server hosting the web site 310. The menu data 311, if present, can be retrieved by the crawler 230, and supplied to the processor 220. Alternatively, the menu data 311 associated with a particular web site can be provided by a third party as a preconfigured data file. The webmaster or owner of the web site can create a file containing the menu data 311, and associate the file with the web site 310 on the server hosting the web site. If the optional local menu data 311 is detected by the crawler 230 when accessing the web site, the data can be retrieved and displayed as described above. Alternatively, the client 100 can provide a request to the crawler 230 to locate and retrieve the menu data 311 embedded in the source code 312 of the web site, if present.

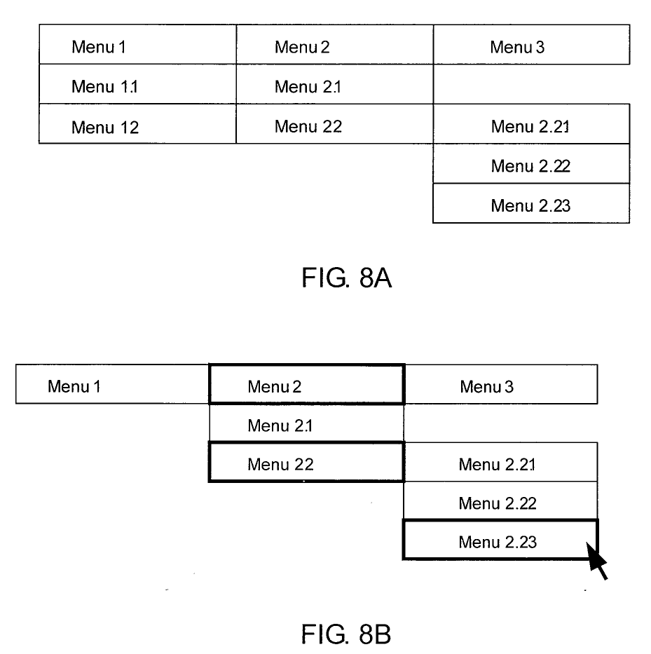

In certain exemplary embodiments of the present disclosure, the menu data can be displayed via an interface comprising drop-down menus, and such menus can optionally be hierarchal. The drop-down menus can enable a user to navigate the web site in a conventional and familiar manner. FIG. 8A shows an exemplary drop-down menu structure generated by the exemplary XML code described above, which corresponds to the exemplary filtered link structure shown in FIG. 6B. FIG. 8B shows the display and selection of hierarchal menus using the menu structure of FIG. 8A.

In certain exemplary embodiments of the system according to the present disclosure, a manual input 250 can be used to provide menu data directly to the processor 220. The manual input can be performed, e.g., by using a menu editor or other software program structured to order or arrange the links located within the web site. The manual input can be provided, e.g., in the form of a file containing the menu data or as a data feed or stream that can serve as input to the database 210.

In one exemplary embodiment of the present disclosure, menu item names, or menu labels, can be translated into different languages. For example, the menu labels can first be stored in the menu database. A dictionary for each desired language can also be stored in the database or in another database that can be accessed. A dictionary can include a list of corresponding words provided in two or more languages. To allow for automatic translation of the menu labels, the most common translation of each word and expression can be provided. The menu labels in the menu data file can then be translated, and the translated results can be stored in the menu file, or alternatively in another menu data file, which can be accessed as described above. Each menu data file can optionally include a marker and/or identifier indicating which language or languages have been used for the menu labels contained therein.

In further exemplary embodiments of the present disclosure, the crawler 230 can be configured to access and identify certain content of a web site by following the link structure contained therein. The links structures can be transmitted to the processor 220, and can be processed and converted to the menu data. The processor 220 can use different methods and/or procedures for generating menu data, which can depend on the structure and the content of the web site. In one exemplary embodiment of the present disclosure, the crawler 230 can detect the existing link structure, filter it for duplicates, and convert this information into the menu data, which can then be stored in the navigation menu database 210. The client 100 can be configured to transmit a request for the menu data to the processor 220 each time the user requests access to an URL via the browser. The processor 220 can then access the navigation menu database 210 to search for menu data associated with the requested URL, retrieve the menu data if located, and provide it to the client 100. If the requested menu data is not available on the navigation menu database 210, the processor 220 can provide the URL of the web site to the crawler 230, and the crawler 230 can then access or crawl the web site associated with the URL to retrieve the site's link structure and generate the menu data, as described above. The URL and information retrieved from the corresponding web site by the crawler 230 can be stored in the crawler database 240.

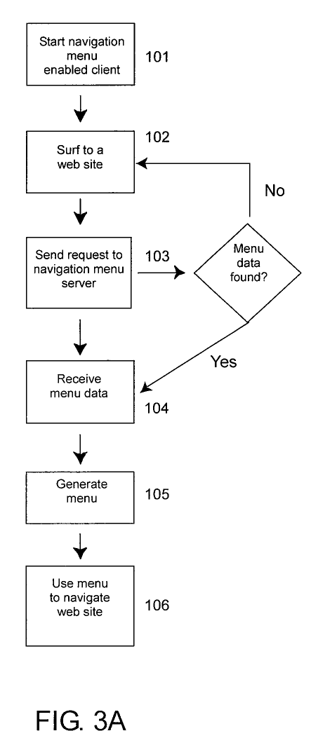

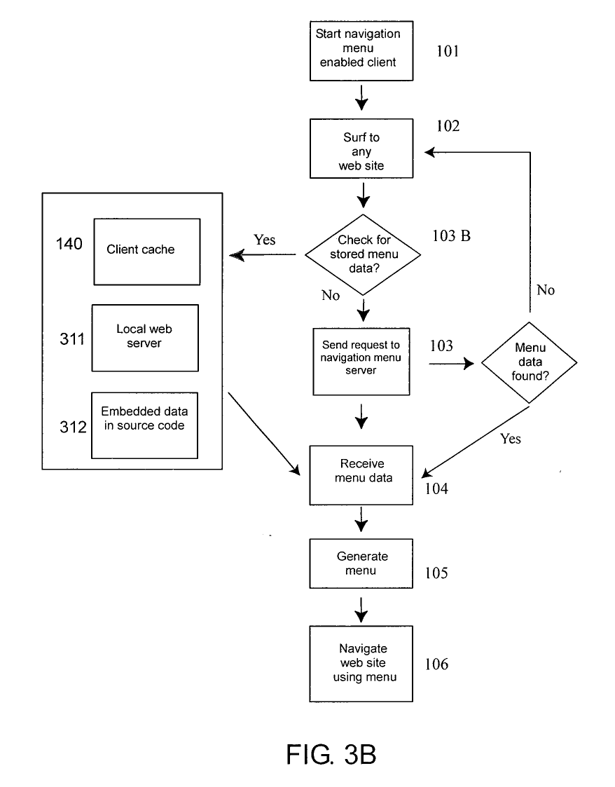

A flow diagram of a method according to certain exemplary embodiments of the present disclosure is shown in FIG. 3A. This exemplary diagram shows exemplary steps that can be used to access and use navigational web page menus. For example, a user can access the navigation menu system by starting a navigation menu-enabled client (step 101). The client can be a browser which is configured to access and display content located on the Internet. The user can then browse the web site (step 102), and the navigation menu-enabled client can then transmit a request to the navigation menu server for the menu data associated with the URL of the web site that the user is browsing (step 103). If the requested menu data is not available on the navigation menu server, then the user can continue browsing without loading the navigational menus (step 102). If menu data corresponding to the requested URL is located, then the navigation menu server can transmit the menu data to the navigation menu-enabled client, which can be configured to receive the menu data (step 104).

After the navigation menu-enabled client receives data from the navigation menu server, a menu can be generated (step 105) and displayed by the client. An exemplary generated menu is shown in FIGS. 8A and 8B. FIG. 8A shows the complete hierarchal menu tree structure associated with the exemplary menu data provided above. FIG. 8B illustrates an exemplary use of the generated hierarchal menus to navigate the web site. In this exemplary menu, the user selected the menu item labeled Menu 2.2, which is a sub-menu item linked to the menu item labeled Menu 2, and has further selected the sub-menu item labeled Menu 2.2.3, which can comprise a link to the corresponding web page entitled “page223” in the code. The user can navigate directly to the web page entitled “page223” within the web site by, for example, clicking and releasing on the menu item labeled Menu 2.2.3 as shown in FIG. 8B (step 106). By using this exemplary navigational menu, the user can directly access the web page associated with the menu item labeled Menu 2.2.3 without having to load, browse or access the intermediate web pages associated with the menu items labeled Menu 2 and/or Menu 2.2. The navigation of the web site can further be performed in this manner without using existing menus or links provided by the web site.

A flow diagram of the method according to further exemplary embodiments of the present disclosure is shown in FIG. 3B, which illustrates exemplary steps that can provide navigational menus which can be used to access the web pages directly. This exemplary embodiment provides an exemplary sequence of steps that includes checking various sources for requested menu data (step 103B), and accessing this menu data if it is available.

A navigation menu-enabled client can search for menu data (step 103B) in a client cache 140, on a local web server 311, or in source code 112 of the web site being accessed. If the menu data is located in any of these locations, it can be compared with menu data that can be stored on a navigation menu server, the most recent data can be provided to the navigation menu-enabled client, and navigational menus based on the current data can then be generated (step 105). If it is not possible, for whatever reason, to determine the most recent version of the menu data found, then the size of the menu data fields can be used. For example, the larger data file can optionally be selected and used to generate menus, based on the assumption that the web site can grow in size and have more web menu data as time passes. Alternatively, the data located on the navigation menu server can be selected as a default option. The order of priority for selecting which set of menu data to use can also be predetermined by an administrator of the web site or server.

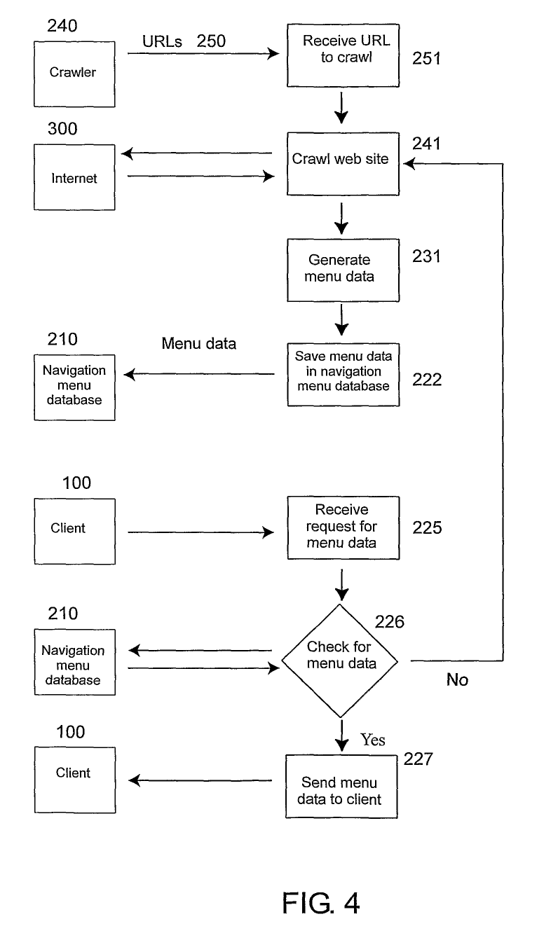

A flow diagram of the method according to further exemplary embodiments of the present disclosure is shown in FIG. 4, which shows exemplary procedures that can be used by a server to provide navigational web page menus. The crawler can receive an URL identifying a web site to crawl or access (step 251) from a crawler database 250. The crawler can then crawl or access the web site (step 241) which can be accessed via the Internet 300. The amount of data obtained by the crawler can depend on the structure and content of the web site. Preferably, only the link structure of the web site can be retrieved and sent to a processor, such as the navigation menu processor 220. Optionally, a greater amount of information or the entire content of certain web sites can be sent to the navigation menu processor 220 and/or to another processor.

The navigation menu processor 220 can then generate the menu data (step 231) based on the data received from the crawler. The menu data can then be recorded in a navigation menu database 210 (step 222), where it can be made available upon request from the client 100. A request for menu data can comprise an URL of a web site that the user is browsing via the client 100. The processor can receive the menu data request from a client 100 (step 225), and then query the navigation menu database 210 (step 228) to determine if the requested menu data is stored therein. If the requested menu data is not available in the navigation menu database 210, the URL can be provided to the crawler, and the crawler can then crawl or access the web site (step 241) to obtain the requested menu data. If the requested menu data is located in the navigation menu database 210, the menu data can be retrieved by the processor and provided to the client 100 (step 227).

FIGS. 5A-5F illustrate certain exemplary embodiments of processes in accordance with the present disclosure that allow generation of a tree structure of the menu data. Several procedures can be employed to generate the tree structure of the menu data. A first exemplary approach, shown in FIGS. 5A-5C, can comprise using links detected within the web site to generate the navigational menu. FIG. 5D shows an exemplary process for generating menu labels for each link and associated menu item. A second exemplary approach, shown in FIG. 5E, can comprise locating and utilizing a catalog structure of the web site as the menu structure of the web site. A third exemplary approach, shown in FIG. 5F, can comprise detecting and utilizing an existing menu system that can be found on the web site.

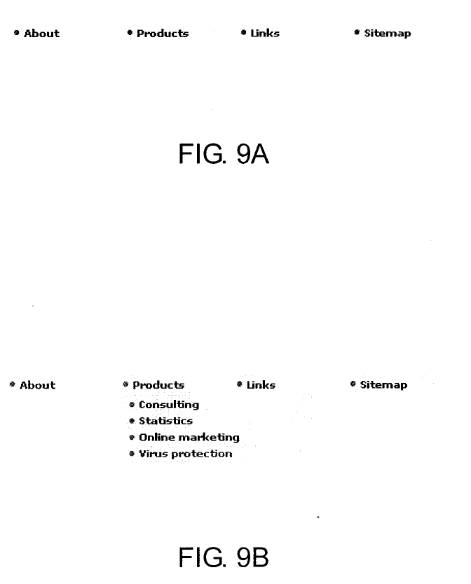

In the exemplary menu data generation process shown in FIG. 5A, the processor receives a link structure associated with the web site from the crawler (step 231A). The link structure can comprise the links located within the web site, which can be presented as a tree structure comprising the pages that the links occur on. The link structure can further comprise the linking relationships between pages, which can specify the target page associated with each link within the web site. To detect the link structure, the crawler can crawl or access some or all links within the web site domain, and can ignore links which already have been detected and/or those which lead to pages outside of the web site (e.g., “external” links). The processor can then generate the menu data based on the link structure (step 231B). Some or all of the links present on the first or main web page of the web site can be configured as top-level links, which can be visible directly in a menu bar or other menu displayed by a client. Examples of such top-level menu items can include the items labeled Menu 1, Menu 2, and Menu 3 in the exemplary menu structure shown in FIG. 9A.

An exemplary web site link structure is shown in FIG. 6A. In this example, only the HTML code of four of the web pages containing new links can be needed to generate the menu data for the entire web site. These four pages are labeled Index.htm, Page 1, Page 2, and Page 2.2 as shown in FIG. 6A. FIGS. 7A-7C show an exemplary HTML code that can be used to generate these four pages, including the URL links that form the link structure shown in FIG. 6A. FIGS. 7A-7D also show the exemplary web pages associated with the exemplary HTML code. The web pages shown in FIGS. 7A-7D contain links to other pages within the web site, consistent with the link structure shown in FIG. 6A.

The exemplary index page shown in FIG. 7A can comprise three links, labeled Menu 1, Menu 2 and Menu 3, together with the URLs of the web pages associated with these links. These three links can be configured as top-level links because they are on the first page of the web site. Page 1, shown in FIG. 7B, can comprise five links as shown in the source code. These links are labeled Menu 1, Menu 2, Menu 3, Menu 1.1 and Menu 1.2. Page 1 can further comprise the URLs associated with the web pages corresponding to these links. These exemplary links can be configured as second-level links, because they are links located on a page that can be accessed via a top-level link.

The generated menu data can be presented in several ways. An exemplary format of the generated data is shown in FIGS. 8A and 8B, and in the code provided above. Each line of the exemplary XML code provided above can contain a menu component together with a name or menu label, together with the URL of a corresponding web page. If the web page associated with the menu component comprises a link to a second page or location, a lower-level menu component can be associated with the second web page. The menu components can be listed or tagged in an appropriate structure to facilitate creation of a corresponding hierarchal menu structure, such as the exemplary structure shown in FIG. 8A.

Certain exemplary menu items can be repeated on several menu levels because the menus containing these menu items can be available on several pages within the web site. An example of a menu item appearing on several pages within a web site can be a menu item in the main menu of the site, because the main menu can be provided on several or all pages within the web site. Alternatively, there can be links to a particular web page stored within or by the web site that are provided on a plurality of other web pages at various levels within the site.

The menu structure generated from the link structure of the web site can be simplified by the use of an exemplary filter procedure, such as that shown in FIG. 5B. In this exemplary procedure, a processor cap receive link structure data associated with a web site from a crawler (step 231A). The menu structure can then be filtered to reduce or eliminate multiple occurrences of links within the menu data (step 232A). The filter process can be performed hierarchically by deleting the links on the lower menu levels if they can be located on a higher menu level of the web site menu structure, where a higher menu level can be understood to refer to a menu level that can be accessed through fewer connected links starting from the top-level or main menu. For example, the menu item labeled Menu 2.2 in FIG. 8B can be considered a second-level menu item that is situated one level below the main menu item labeled Menu 2, whereas the menu item labeled Menu 2.2.1 can be considered as a third-level menu item because it is situated two levels below the main menu item labeled Menu 2 and one level below the second-level menu item labeled Menu 2.2. Alternatively, when the crawler detects a web page that has already been accessed on the web site, it can associate the page within the link structure at a position that will have the shortest path to the top-level links. The processor can then generate menu data based on the filtered link structure (step 231B).

The link structure of a web site can be viewed as a network of nodes, where every page can be considered as a node and every link can be considered as a way to travel or have access from one node to another. An exemplary node structure corresponding to a web site is shown in FIGS. 6A and 6B, where the rectangular web pages can represent nodes, and the arrows and black lines connecting them can represent links. The link between any two connected nodes can be one-directional, unless two pages each contain a direct link to the other. Each link can be considered to have a unit length. For example, the shortest path calculated between two nodes can be used to determine where in the link structure the pages or nodes can be located and a page or node can be placed in a position that provides the shortest path to the top level. If a specific web page has two or more different paths to the main or top-level web page that are of equal length, then all but one path can be discarded when filtering the menu data or duplicate links to the page can be allowed. External links that connect to other web sites can be discarded when generating the menu data. Alternatively, some or all links to one or more external web sites can be included in the menu data of a given web site if desired.

The link structure of an exemplary web site is shown in FIG. 6A, where the dark lines and the arrows can represent links between web pages. The arrows in FIG. 6A can indicate that the top level menu structure, comprising links to Page1, Page 2 and Page 3, can be available from all web pages. These arrows can be considered to be secondary or back links. The exemplary filter process can detect these secondary links and can delete them to simplify the generated menu structure. The result of the filtering process can then be represented by the exemplary menu structure shown in FIG. 6B.

This exemplary filtering process can be described in more detailed with reference to the source code of the four web pages shown in FIGS. 7A-7D. For example, when the links on Page 1 in FIG. 7B. are filtered, menu data corresponding to the links Menu 1, Menu 2, and Menu 3 (which are links to Page 1, Page 2, and Page 3, respectively) can be deleted because those links can have already been detected on the Index.HTML page shown in FIG. 7A. The links labeled Menu 1.1 and Menu 1.2 (which are links to Page 1.1 and Page 1.2, respectively) can be retained in the generated and filtered menu data. In a similar manner, the links labeled Menu 2.1 and Menu 2.2 can be retained in the menu data as menu items and links associated with the exemplary web page labeled Page 2, shown in FIG. 7C. These links can be the second-level menus under the Menu 2 menu item, and they can also be stored as the second-level links for this exemplary web site, because they are located at the second level of menu links, below the Menu 2 link located at the first or top level. The web page labeled Page 2.2, shown in FIG. 7D, can include HTML code that contains links to Page 1, Page 2, Page 3, Page 2.2.1, Page 2.2.2, and Page 2.2.3. The links to Page 2.2.1, Page 2.2.2, and Page 2.2.3 can be placed in the menu data at a third level, because these pages are located one level below Page 2.2, which can be considered to be a second-level page. During the exemplary filtering process, the links associated with Menu 1, Menu 2 and Menu 3 can be deleted from the link structure directly associated with Page 2.2, and data associated with menu items Menu 2.2.1, Menu 2.2.2 and Menu 2.2.3 can be retained and stored as third-level links.

The code provided above shows an exemplary set of menu data generated from the web site link structure shown in FIG. 6A, after duplicate links and back links have been deleted by the exemplary filtering process described above.

A graphical block diagram illustration of an exemplary embodiment of a complete menu structure generated for the exemplary web site link structure of FIG. 6A is shown in FIG. 9A. The top-level menu can comprise the menu items labeled Menu 1, Menu 2 and Menu 3, and can include links from the Index.htm page to Page 1, Page 2 and Page 3, respectively. The menu item labeled Menu 1.1 can contain a link from Page 1 to Page 1.1, and the other menu items shown in FIG. 9A can contain similar links to the appropriate web pages shown in FIG. 6A.

FIG. 8B shows an exemplary block diagram of the menu data described above as it can appear while being displayed and used via a client. The black arrow can represent a cursor or other pointing indicator that can interact with the browser or other web content display on the client. Placing the cursor over the menu item labeled Menu 2 in the top-level menu can reveal the lower-level menu items labeled Menu 2.1 and Menu 2.2. The user can then move the cursor over the lower-level menu item labeled Menu 2.2, which can then reveal the next set of lower-level menu items labeled Menu 2.2.1, Menu 2.2.2, and Menu 2.2.3. The user can then move the cursor over the now-revealed menu item labeled Menu 2.2.3 and, by clicking a mouse button or performing another appropriate selection action while the cursor is pointing to this menu item, the user can activate the link associated with this menu item and navigate directly to Page 2.2.3. This process allows the user to navigate, e.g., directly to Page 2.2.3 and view its contents without having to load or otherwise access the intervening web pages labeled Page 2 and Page 2.2.

In certain exemplary embodiments of the present disclosure, a main menu of the web site can be provided and displayed while any page is being browsed or viewed within the web site. The web sites can have several shortcuts in their link structures, and they can include more than one link leading to a particular web page. A main index page provided by the existing web sites can have more links than can be desirable or practical in the top level menu, including direct links to some of the web pages that can be placed further down in the link structure hierarchy. Also, the space available to display top-level links can be limited by the use of certain web browsers or small-screen displays, particularly when the menu data can be presented in the form of a menu bar.

An exemplary process for detecting the top-level links within a web site and generating a top-level menu is shown in FIG. 5C. In this exemplary process, a processor can receive a link structure associated with the web site from a crawler (step 231A). For example, all of the links located on the front page of the web site can then be detected (step 233A). All of the links located on the next level of web pages can then be detected (step 233A). Initially, these web pages can include those that are linked directly from the front page, and can be considered as second-level links associated with the web site link structure. Links that are detected on both the front page and the second level of the web site structure can be identified as top-level links. These top-level links can be ordered according to the number of times they are detected, and links that appear on a larger number of pages within the web site can optionally be listed towards the top of the menu data listing. A partial menu structure can then be filtered to eliminate duplicate occurrences of the links within the menu data being generated (step 232A). After filtering, a next-lower level of links that includes links contained within the web pages of the current level can be detected. These next-lower level links can also be filtered as described above. The process of detecting and filtering the next-lower level of links can be repeated until all pages within the web site have been accessed. The processor can then generate the menu data based on the link structure obtained using the exemplary process described above (step 231B).

The top-level menu of the exemplary web site link structure shown in FIG. 6A can include the top level links labeled Menu 1, Menu 2 and Menu 3. The top-level menu can also be displayed as the top row of menu items shown in FIG. 8A.

In certain exemplary embodiments of the present disclosure, the size of the menu for the web site can be limited or truncated when obtaining menu data and generating the menu structure. The web sites can have thousands of web pages or more, and a navigational menu that can access each of these pages can be cumbersome and inconvenient. Also, it can be preferable to limit the number of menu items and associated links in a single sub-menu so that the hierarchal menus do not become too large and unwieldy to navigate or scroll through.

The menu size can be limited, e.g., by only including links internal to the web site (links within the same domain) when generating menu data, and ignoring links that lead to web pages outside of the web site domain. The menu size generated for a given web site can also be limited by specifying a cut-off level that corresponds to a maximum number of levels below the top level to crawl. The level or depth of a web page can be defined by the number of links present in the shortest path between the web page of interest and the top-level page. The exemplary embodiment of the process for generating the menu data according to the present disclosure shown in FIG. 5C can be stopped after filtering the links (step 232A) detected within the selected cut-off level, and then a final set of menu data can be generated (step 231B). Links on web pages that are at a deeper level than the selected cut-off level can be ignored, thus limiting the size of the navigational menus generated for the web site.

Alternatively, the size of the navigational menus generated can be reduced by limiting the total number of web pages and corresponding menu items to store as the menu data and/or to display for a certain web site. The size of the generated menus can also be limited by keeping only links to the web pages that have a predetermined page rank in the generated menu data. The page rank used in this exemplary process can be determined based at least in part on the level of the web page and/or the number of pages linking to the web page. Another option for limiting the size of the generated menus can include limiting the number of links and corresponding menu items associated with a web page to the number of menu items that can be clearly and/or conveniently displayed on the client or web browser. The links that are maintained within the menu data can be selected based on their relative ranking as described above. For large web sites, it can also be desirable to limit the number of menu items in the generated navigational menus to a number that can be updated within a reasonable timeframe.

FIG. 5D illustrates another exemplary process for generating a tree structure of menu data in accordance with certain exemplary embodiments of the present disclosure. This exemplary process is generally similar to the exemplary process shown in FIG. 5B, and further includes the generation of labels or names for menu items (step 233C). For example, the link text associated with a menu item or a portion thereof can be selected as a label for the corresponding menu item. The link text can include the text which appears together with the link on a client display, and which can be displayed to the user on a web page when it is viewed, e.g., via the web browser. The displayed link text can be underlined, and can also be displayed in a different color than the surrounding text. By performing a mouse click on displayed link text, the link associated with it can be activated. Examples of the link text can include the labels Menu 1, Menu 2 and Menu 3 shown on the exemplary web page in FIG. 7A.

Certain exemplary links can be accessed by clicking on a graphic element displayed on the web page, and can not have any link text associated with them. Examples thereof can include clickable buttons or other graphic elements such as a .JPG or .GIF image that can further comprise text within the graphic element. Menu item labels can be generated for the links associated with graphic elements using, e.g., conventional character recognition of the displayed text within the graphic elements, if any such text is present. Alternatively, if no text is detected as part of the graphic element, or if the graphic element is not displayed, an ALT tag can be used as a menu item label for the link. If there is no ALT tag present, the title of the target page associated with the link, or a portion thereof, can be selected as the menu item label. If there is no title on the target web page, a headline or first line of text in the body of the target web page can be selected as a menu item label. If there is not text present on the target web page, the file name of the document can be used. The menu item label generated by any of the exemplary processes described above can be truncated as appropriate.

FIG. 5E illustrates yet another exemplary process for generating menu. data based on the directory structure of the web site, in accordance with certain exemplary embodiments of the present disclosure. Static HTML web sites and web sites that use a publishing system can include a hierarchal directory-based system to organize individual web pages within the site. Sections and subsections of the site can be organized by using path names that include directory and subdirectory names separated by a slash (“/”). An example of such a directory structure extending through three directory levels can be as follows:

<tb><sep>http://www.web site.com/
<tb><sep>http://www. web site.com/SPORTS/
<tb><sep>http://www. web site.com/WEATHER/
<tb><sep>http://www. web site.com/NEWS/
<tb><sep>http://www. web site.com/NEWS/local/
<tb><sep>http://www. web site.com/NEWS/national/
<tb><sep>http://www. web site.com/NEWS/international/

In the exemplary process for generating the menu data shown in FIG. 5E, the processor can receive the full URL for some or all pages within a certain web site (step 234A). The processor can then detect and identify the directory structure based on the URLs, optionally remove duplicate links or subdirectories, and order the URLs in a sorted list (step 234B). Each item in the sorted list can represent a menu item, and the menu items can be ordered in a format similar to a directory tree. An example of a sorted directory tree can be as follows:

<tb><sep>Main menu
<tb><sep>SPORTS
<tb><sep>WEATHER
<tb><sep>NEWS
<tb><sep>local
<tb><sep>national
<tb><sep>international

The directory tree can then be converted into the menu data (step 234C). The first level directory can be used to generate top-level menu items, and the next level of the directory can be used to generate the next level of menu items, and so on, until the desired number of levels of the directory structure have been used to generate corresponding levels of menu items. If there is a large number of directory levels, the number of levels in the generated menu data can be truncated as described above. Optionally, menu data generated by using the directory structure as described above can be compared with and/or validated by menu data generated by any of the other processes described herein.

The menu data can be generated from an existing menu structure associated with a particular web site, if present. An example of such a process is shown in FIG. 5F. For example, a processor can receive full source code associated with a web site from the crawler (step 235A). The crawler can be configured to detect only the HTML code associated with the web pages, and to ignore scripts, tags and/or other specific elements to improve crawling efficiency. To detect an existing menu system, the full source code associated with the web site can be gathered by the crawler and provided to the processor. The processor can then detect an existing menu structure (step 235B) by detecting clusters of links, rows and columns of links in tables, bullet lists, Cascade Style Sheets that can format the link structure, JavaScript objects comprising links, etc., that can be contained within the provided source code. After detecting the menu structure, the processor can generate the corresponding menu data (step 235C).

An example of the navigational menus generated from the existing menu structures is shown in FIGS. 9A and 9B. The main menu of an exemplary web site is shown in FIG. 9A. This menu can be generated by the following exemplary source code through the use of a conventional stylesheet:

<tb><DIV id=menuframe>
<tb><sep><UL id=nav>
<tb><sep><LI><A href=“ http://www.website.com/
about.HTML”>About </A></LI>
<tb><sep><LI><A href=“ http://www.website.com/
products.HTML”>Products</A>
<tb><sep><UL>
<tb><sep><LI><A href=“
http://www.website.com/consulting.HTML”>Consulting</A>
<tb><sep></LI>
<tb><sep><LI><A href=“
http://www.website.com/statistics.HTML”>Statistics</A></LI>
<tb><sep><LI><A href=“http://www.website.com/
online_marketing.HTML”>Online
<tb>marketing</A></LI>
<tb><sep><LI><A href=“ http://www.website.com/virus.HTML”>Virus
protection</A>
<tb><sep></LI>
<tb><sep></UL>
<tb><sep></LI>
<tb><sep><LI><A href=“ http://www.website.com/
links.HTML”>Links</A> </LI>
<tb><sep><LI><A href=“ http://www.website.com/
sitemap.HTML”>Sitemap</A>
</LI>
<tb><sep></UL>
<tb></DIV>

If a stylesheet was not used, the menu can be displayed as an ordinary bullet list, such as the exemplary sorted directory tree provided above. The submenus associated with the exemplary source code listed above are shown in FIG. 9B. These submenus can be generated using stylesheets, JavaScript, or by other conventional way of generating hierarchal menus.

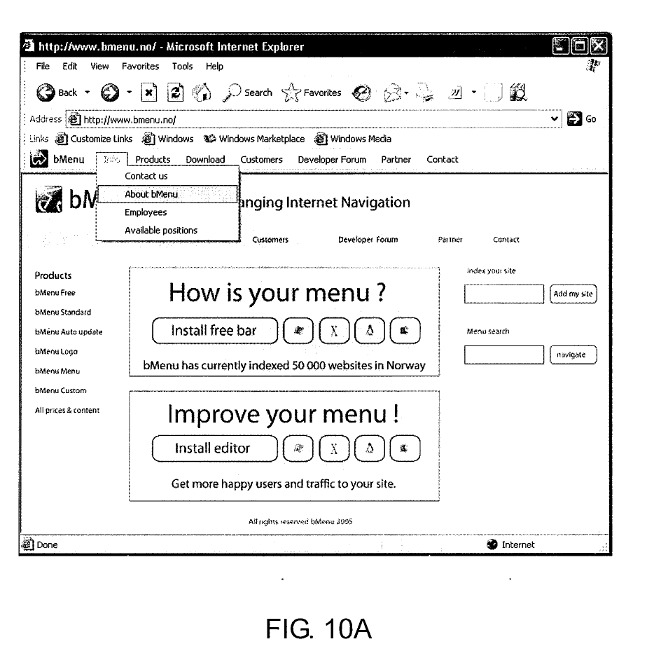

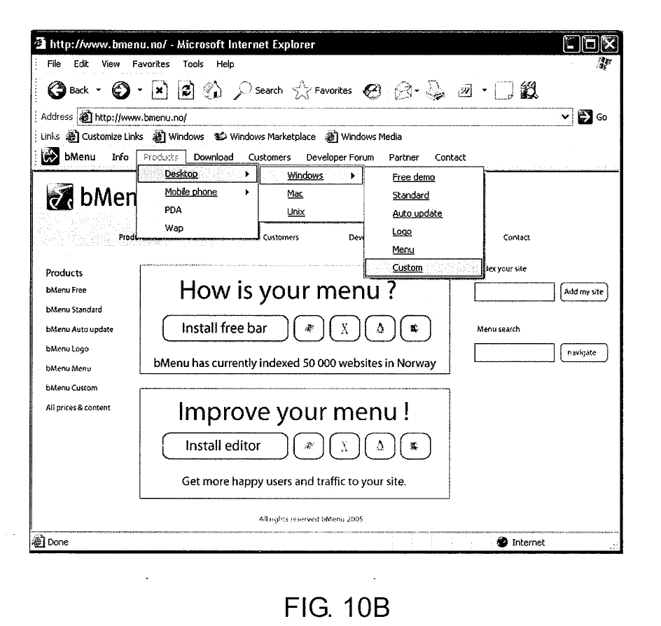

FIG. 10A shows an exemplary web site navigational menu that can be generated and displayed according to certain exemplary embodiments of the present disclosure. Pre-selected top-level and/or sub-menu items can optionally be generated for web sites where a specific predefined content is detected. For example, an Info menu item can be automatically generated and associated with a link to a page containing certain content detected within a web site. By detecting the specific content or content having a predefined format on a web page within the web site, a standardized menu item can be generated which can link to the web page containing the specific content on any web site, if present. For example, a “Contact us” menu item can be provided for the web site, and linked to a web page containing contact information. To select the web page to link to from the “Contact us” menu item, variables such as the text “contact us,” phone number formats, e-mail formats, and the like can be provided to a content detection module. The module can then identify the web page where these words and formats occur most frequently, and can link this page to the menu item named “Contact us” under the Info menu. This exemplary procedure can be repeated for each web site accessed by the client.

Other types of content can also be linked to predefined menu items in the generated menus, such as the “Employees” and “Available positions” menu items shown under the Info menu item, as shown in FIG. 10A. To increase the accuracy of detected content, each variable used to identify specific content can be assigned a weighting factor. The weighting factor can also be affected by the location of a detected variable on a web page (e.g., the weighting factor can be larger if the detected content is located at or near the top of a web page), by other links or text detected on the web page, and the like.

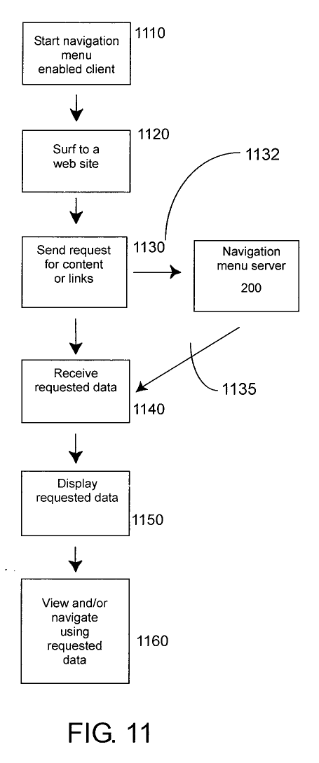

In further exemplary embodiments of the present disclosure, a system, process and software arrangement can be provided that can allow browsing of web pages on small-screen devices that includes display of either page links or page content. For example, FIG. 11 shows an exemplary client-side flowchart in accordance with certain exemplary embodiments of the present disclosure. A user can start a navigation menu-enabled client (step 1110) such as, e.g., a browser capable of use on small-screen devices, for example, an Opera mini browser. The client can then connect to a web site or a particular web page (step 1120) associated with a URL entered or selected by the user.

The user can also provide a request for what content associated with the web page to load and/or display (step 1130). The requested content can be, e.g., page links or page content. A page link can include a link (e.g., a URL or computer code which can include a URL) which can identify a web page associated with the web site that includes the particular web page, a web page associated with another web site, and/or a particular location on a web page. Web content can include, e.g., textual material present on a web page such as, for example, articles, messages, image captions, etc., and/or graphical images, embedded video clips, etc. Page links can also have a form of embedded links which can include, e.g., certain portions of text and/or graphical images associated with the page content which can have a link associated with them.

The navigation menu server 200 can receive the request 1132 and can generate the requested data 1135. The client can then receive the requested data 1135 (at step 1140) from the navigation menu server 200.

The requested data 1135 can then be displayed by the client (step 1150), e.g., on a small-screen display. The requested data 1135 thus displayed can be can viewed by the user and/or used to navigate to a further web page if page links are included in the requested data 1135 (step 1160). A new request for data associated with the further web page can be provided, e.g., by the user (step 1130).

Different content associated with the web page being viewed can also be requested (step 1130). For example, if a user first requests page content for a particular page (step 1130), a further request can then be made to display page links associated with the web page (step 1130). Alternatively, after viewing requested page links associated with a web page (step 1160), a user can also request page content associated with the same web page (step 1130).

An option can also be provided to load a particular web page using conventional techniques, in which both page links and page content can be displayed. Such an option can be processed for the particular web page without using the navigation menu server 200.

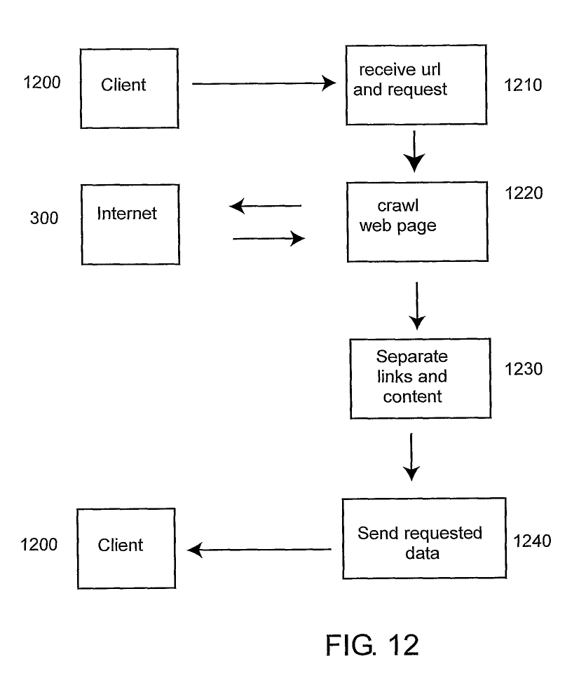

FIG. 12 shows an exemplary flowchart of server-related processes which can be performed in accordance with certain additional exemplary embodiments of the present disclosure. For example, a navigation menu server 200 can receive a URL and a request from a client 1200 (step 1210). The request can be for page links and/or page content associated with the URL. The client can be, e.g., a small-screen device or other device capable of accessing, providing and/or displaying web pages. The crawler can then access the Internet 300 to “crawl” or obtain data from the web page associated with the URL (step 1220). The page links and page content associated with the web page can then be identified and separated (step 1230). The requested data can then be transmitted to the client 1200 (step 1240), and can be viewed and/or used, e.g., to navigate to other web pages or within a web page by the user.

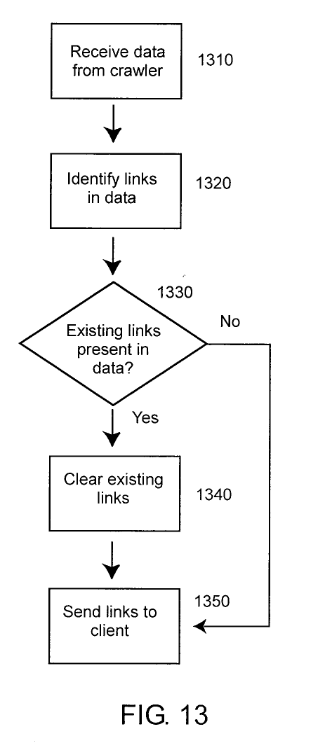

FIG. 13 shows an exemplary flow of a procedure which can be used for identifying and/or generating page links associated with a web page in accordance with further exemplary embodiments of the present disclosure. The navigation menu server 200 or another processor can receive data associated with a web page from a crawler or other data storage arrangement (step 1310). Links which can be present and/or accessible on a the web page can be identified or located (step 1320), for example, by scanning the source code associated with the web page for links. The server can then determine if other pages within the same website have been accessed or viewed recently, e.g., within the same browsing session or within a certain time period. This can be performed, e.g., by comparing previously requested URLs with the current URL and/or by matching the domain associated with the current web page to that of other web pages previously viewed. If other pages within the web site have been accessed recently, the server can also determine if existing links associated with these other pages are present within the data associated with the current web page (step 1330).

If other web pages associated with the same web site has been recently viewed or accessed, links which were found on previous web pages that are also identified on the current web page can be cleared or grayed out (step 1340). The remaining page links can then be sent to the client (step 1350) for viewing and/or to be used for navigating to further web pages. For example, if no web page associated with the same web site has been accessed recently, or no links on the current web page are the same as other links found on recently-accessed web pages, then the page links identified on the current web page can be sent directly to the client without clearing any links.

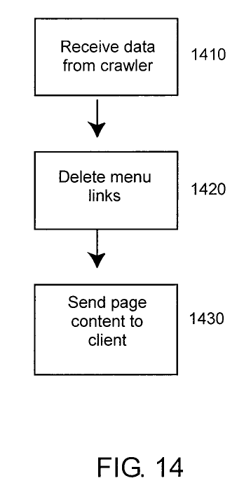

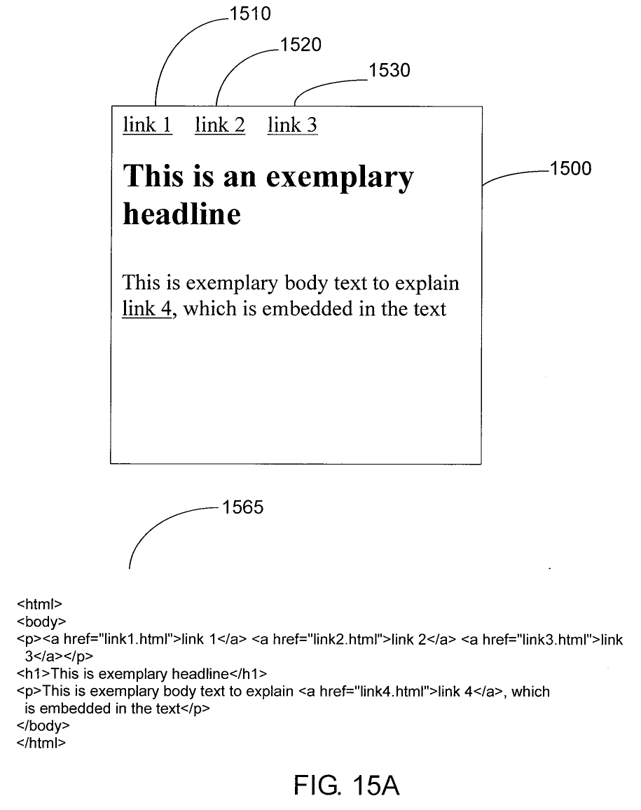

An exemplary flow chart of a technique for separating out page content in accordance with yet additional exemplary embodiments of the present disclosure is shown in FIG. 14. Page content can include, e.g., text and/or images associated with a web page, and can exclude, for example, menus or separate links which can be present on a web page. To separate page content on a web page being accessed, the navigation menu server 200 or another processor can receive data from a web crawler or other source such as, e.g., a memory storage device (step 1410). Menu links identified within the data can be deleted or, alternatively, stored in a separate file or data structure (step 1420). Text which can correspond to links that are embedded in the text can be kept as part of the page content, and such links can also be stored in a separate file or data structure. The requested page content, which can have separate links and/or menus removed, can be sent to the client (step 1430), e.g., for viewing on a display.

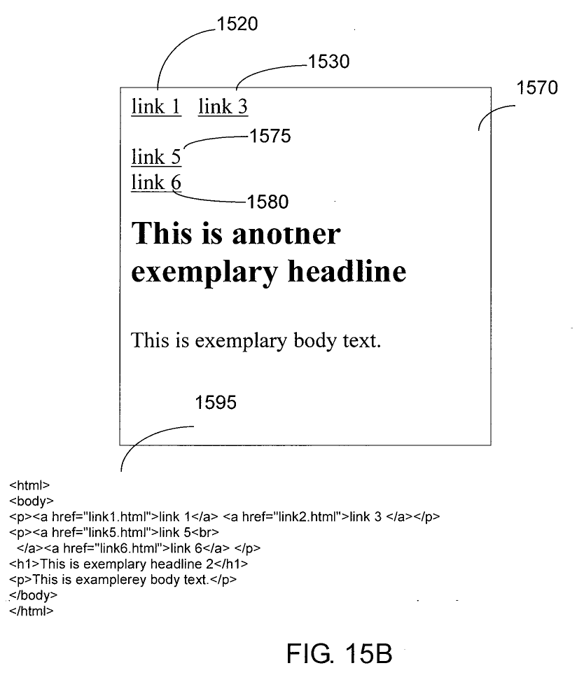

Examples of techniques described herein to identify and/or separate page links and page content are illustrated, e.g., in FIGS. 15A-17B. For example, FIG. 15A shows an exemplary web page 1500 and an exemplary code 1565 which can be used to generate the page 1500. If the web page 1500 and/or the associated code 1565 is scanned or examined for links, links link 1 1510, link 2 1520, link 3 1530 and link 4 1540 can be identified.

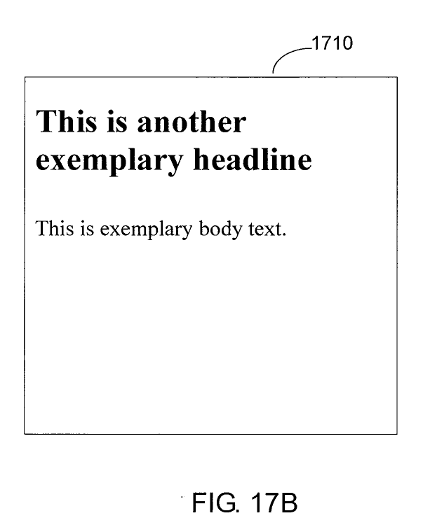

An example of an embedded link 1540 is also shown in FIG. 15A. The embedded link can be, e.g., a link which can have text before and/or after the link. Text associated with the embedded link text 1540, e.g., “link 4,” can be identified as part of the text 1560 which can be included in the page content. A display of filtered page content which can be identified with the exemplary web page 1500 is shown in an exemplary web page 1700 in FIG. 17A. This page content can not include separate links 1510-1530, and it can include the text associated with embedded link 1540. Identification of the page content can also include, for example, another filter procedure that can include long text strings associated with links as part of the page content. Such a filtering procedure can prevent, e.g., deletion of headlines which can be presented as links. Identification of page content can also include identifying text that is formatted using tags such as, e.g., H1, which can be associated with a headline, and including such text as part of the page content.

FIG. 15B shows an exemplary second web page 1570 and an exemplary code 1595 which can be used to generate the second page 1570. The second page 1570 can be associated with the same web site as web page 1500 shown in FIG. 15A. The links link 1 1510, link 2 1520, link 5 1575 and link 6 1580 can be identified on this web page 1570. A display of the filtered page content which can be identified with the exemplary web page 1570 is shown in an exemplary web page 1710 in FIG. 17B. This filtered page content may not include separate links 1510, 1530, 1575 or 1580, which can be present on the second web page 1570. Such a display of filtered page content can provide an improved browsing experience, e.g., by allowing a user to view the page content directly, without having to scroll past or otherwise navigate around any displayed page links. This can be particularly useful when viewing web pages which contain many page links.

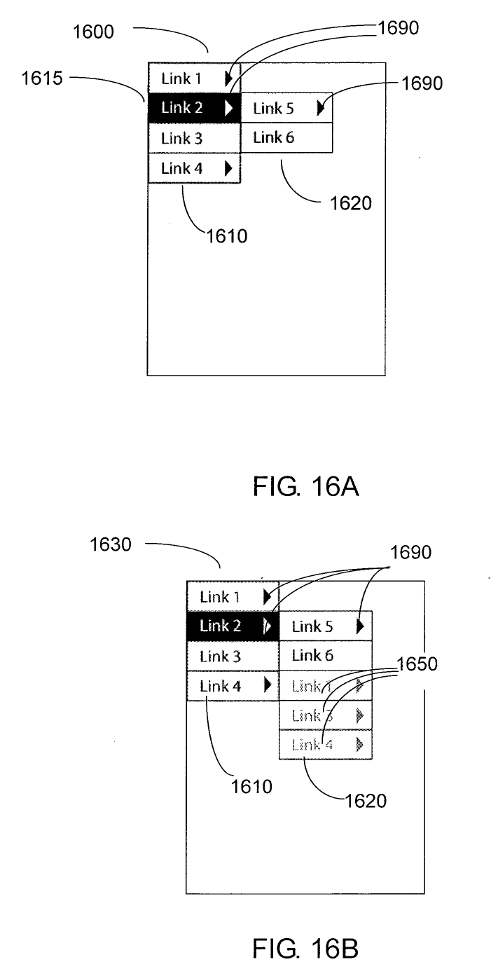

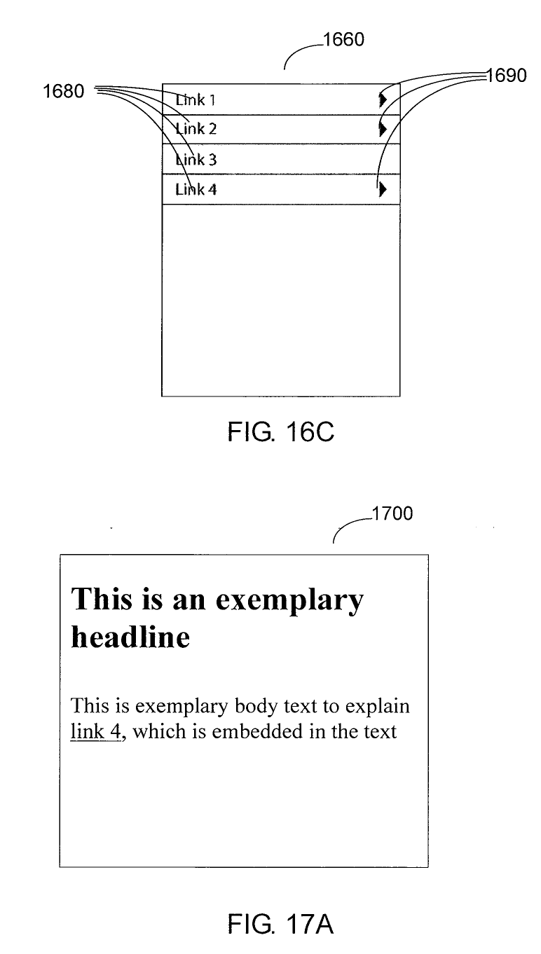

In exemplary embodiments of the present disclosure, the page links can also be provided in a form of a menu structure. For example, an exemplary menu structure 1600, which can be generated using links identified on web pages 1500 and 1570 in FIGS. 15A and 15B, is shown in FIG. 16A. The menu structure 1600 can be generated using exemplary link filtering processes described herein. For example, the leftmost column 1610 of the menu structure 1600 can provide menu items which can allow access to the links labeled “link 1” through “link 4” 1510-1540 associated with the web page 1500. The other menu column 1620 of this menu structure 1600 can contain the links labeled “link 5” 1575 and “link 6” 1580 on the second web page 1570 shown in FIG. 15B. The links labeled “link 1” 1510 and “link 3” 1530, which are present on the second web page 1570, may not have corresponding menu items on the menu column 1620 associated with this page. These two links are already present on another web page 1500 associated with the same web site, and thus these duplicate links can be filtered out to provide, e.g., a more convenient and/or manageable menu structure such as the one 1600 shown in FIG. 16A.

A further exemplary link filtering procedure can be used to remove, e.g., duplicate links which can appear on a single web page. For example, links to a particular web page can be present at two or more locations on a web page of interest. To remove duplicate links on a web page, the shortest links can be deleted first. Certain types of links can also be stored, e.g., in a list or a database, and links on a web page that match such types of links can also be removed or filtered out when providing requested page links. Links that can be filtered out can include, e.g., links labeled “read more,” “page 2,” etc. A link filtering procedure can also be performed on more than one page associated with a web site, which can generate larger menus and/or improve the speed of providing menu structures associated with page links. Information describing filtered page links associated with a particular web page or web site can also be stored, e.g., on a server or in a memory storage arrangement, which can provide faster handling of repeated requests for such pages or sites.

Page links can be displayed by a browser in several ways. For example, the menu structure 1600 shown in FIG. 16A can provide an interface that allows a user to see two levels 1610, 1620 of filtered links on the screen at the same time. An alternative exemplary menu structure 1630 shown in FIG. 16B includes recurring links 1650 which are grayed out. An option can be provided for a user to display only new links, as shown in FIG. 16A, or all links as shown in FIG. 16B. In certain exemplary embodiments of the present disclosure, a single-level menu structure can be provided to display page links. The exemplary menu structure 1660 shown in FIG. 16C, for example, can display menu items associated with only links that are present on a current web page. When using this type of single-level menu structure, the entire menu can change when navigating to a different web page.

The generation and display of menu structures using page links, after filtering out page content, can facilitate navigation of web pages. A user can directly view and explore links present on web pages without having to read through page content and/or locate the page links on a page directly. Navigation of web pages can be performed in several ways using various forms of menu structures. For example, menu items corresponding to page links associated with a further page can be displayed, e.g., when a user moves to the right in the menu. A user who can have highlighted the menu item 1615 in FIG. 16A can then move a cursor or other indicator to the right, which can result in a second column of menu items 1620 being generated and/or displayed. The menu item 1615 labeled “link 2” can contain a link to the second web page 1570 shown in FIG. 15B. The menu items in the menu column 1620 can correspond to, e.g., links on the second web page 1570. Indicators such as, e.g., triangles 1690 shown in FIGS. 16A-16C can be provided in certain menu items to indicate that a further menu column can be associated with the menu item. Each menu column, such as the two columns 1610, 1620 shown in FIG. 16A, can correspond to links associated with a particular web page. Menu items which do not contain such a marker can indicate, e.g., that there are no further links associated with the web page corresponding to the menu item.

Various exemplary user options can also be provided to request, e.g., display of page content associated with a particular web page. For example, the leftmost column 1610 of the menu structure 1600 shown in FIG. 16 can provide menu items corresponding to the links 1510-1540 on the web page 1500 shown in FIG. 15A. The inverted menu item 1615 can represent a link to the second web page 1570 shown in FIG. 15B. Clicking on or selecting this menu item 1615 can send a request to load and display filtered page content for the second page 1570. The exemplary filtered content 1710 for the second web page 1570 is shown in FIG. 17B. A “switch” or “back” button, which can be provided in a form of, e.g., a physical button on a client, a displayed icon, or particular location on a display (for example, a corner of the display screen), can be used to return to a menu display from a display of page content, or vice-versa.

A user can also request display of either page content or page links using the exemplary menu structures shown in FIGS. 16A-16C. For example, the user can highlight and select one of the menu item labels 1680 shown in FIG. 16C to request that page content from the web page associated with the menu item be obtained and displayed. Alternatively, the user can select one of the triangular indicators 1690 to send a request to generate and display a menu structure containing page links from the same web page. A “switch” or “back” button, as described herein, can also be used to switch between displaying page content and page links associated with a web page.

Various techniques described herein for generating menu structures and menu item labels can also be applied when using filtered data associated with a web page (which can, e.g., include page links and exclude page content). For example, concise and descriptive menu labels can be generated, and/or menu sizes can be truncated using the various procedures described herein.

The aspects of the disclosure described above primarily relate to the creation and storage of a navigation menu based on a web site link structure, and how such a menu can be accessed by a client device. However, particularly when the hierarchical structure of a web site is complex and it is not self evident where in the structure a particular type of information can be located, navigating the menu structure in order to access desired information can still be difficult for a user.

Consistent with the principles of the disclosure, methods of searching and presenting information items located in a menu structure have been provided. Access to menu items several levels down in the menu structure can then be provided without navigation through intermediate menu levels being necessary. According to some embodiments of the disclosure, such methods can be used to navigate menu structures not only related to web site information but also other menu structures.

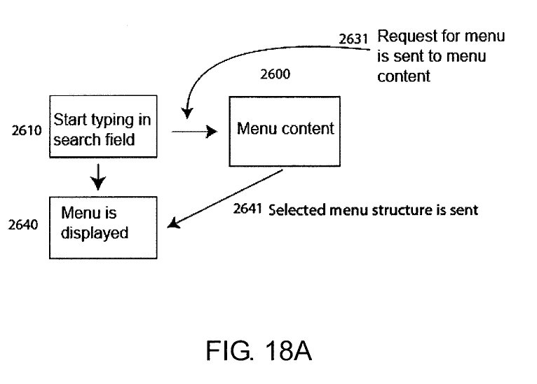

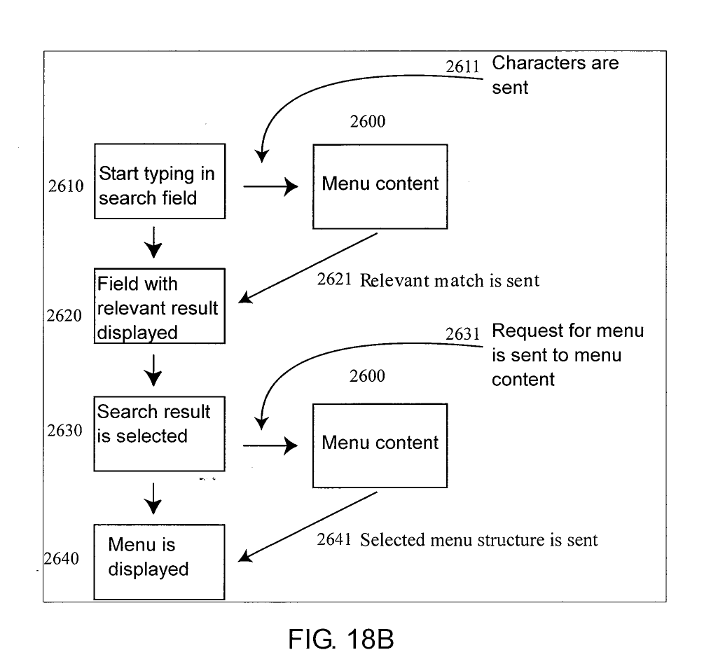

FIG. 18A shows an exemplary client flowchart of how this can be carried out. The user types characters into a search field 2610. The characters can be sent 2611 as a search request to be performed on available menu content 2600. After a comparison of the search request characters with the available menu content 2600 is performed, a most relevant menu element can be identified, and a menu structure which includes the most relevant menu element can be provided 2641. The menu structure containing the most relevant menu element can then be displayed with the selected menu element highlighted 2640. In this exemplary embodiment of the present disclosure, the search request can generate a single result which includes at least a portion of a menu structure containing the most relevant menu element. For example, the most relevant menu item can be selected based on one or more criteria such as, e.g., an exactness or closeness of a match between the search characters and a menu item label or pointer, a depth within the menu structure hierarchy, etc.

FIG. 18B shows an exemplary client flowchart. Here the function of displaying alternatives before opening the menu has been added. The user can type characters into a search field 2610. The characters can be sent 2611 e.g. as a search request to be performed on available menu content 2600. Relevant menu content, e.g., menu items which match or are otherwise relevant to the characters, can be sent back 2621 to a user. Such relevant menu items can include menu items identified within the available menu content which my include an exact match with the characters and/or one or more menu items which are otherwise relevant to the characters. Relevant menu items can be selected based on one or more criteria such as, e.g., an exactness or closeness of a match between the search characters and a menu item label or pointer, a topical similarity between the search characters and a label or pointer associated with a menu item, etc. The relevant menu content can be displayed, for example, in a results field located below the search field 2620. The results field can include, e.g., a list of the relevant menu items which can be provided as a drop-down menu structure. The relevant menu items can include, e.g., menu items which have a label or a pointer that can begin with or contain all or most of the characters entered in the search field.

The user can then select a particular menu item from the displayed result 2630. When a particular menu item is selected, a request for the selected menu item can be sent 2631 to menu content 2600. The selected menu structure can then be sent back 2641. The menu structure can then be displayed with the selected menu element highlighted 2640.

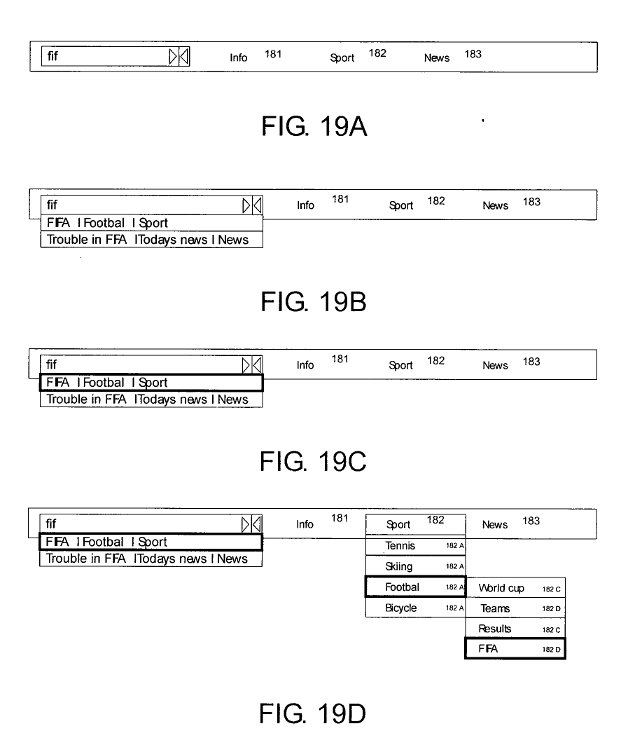

Reference is now made to FIG. 19A, FIG. 19B, FIG. 19C and FIG. 19D, which show exemplary user interfaces where a menu search is performed in a web browser. Consistent with principles of the disclosure, a user interface part of a browser application can have a search entry field wherein a user can enter a search term or search phrase he or she wishes to search for.

After a search has been performed in the hierarchical structure of information items, a list of hits can be presented on the user interface, for example adjacent to the search field. According to some embodiments of the disclosure, the list of hits can be a drop down menu that appears near the search field displaying hits that start with or include the word or phrase entered by the user.

The search in hierarchical structure can be performed every time the user enters a character in the search field, creating a dynamically updated list of hits that changes as soon as the user changes the search terms. However, in order to avoid the generation of an unnecessary long list of irrelevant previous searches, the result list can only be generated after a certain number of characters have been entered. For example, a first search in the list of previous searches could be performed after the user has entered three characters, and subsequently every time the user enters an additional character (or removes a character). The disclosure is, of course, not limited to this example, and the search could be performed after any arbitrary number of characters (including for example one, two, four or five) have been entered, as determined according to design criteria, or as part of a user configuration.

The user can now select one of the entries shown in the drop down menu and perform a search using the selected search term.

In the example illustrated in FIG. 19A the user has entered the characters “fif” in such a search entry field 2610 of a menu bar 2605. After the local menu content is searched, two relevant menu items 2620, 2630 containing the characters “fif” can be identified and displayed in a drop down menu below the search field, as illustrated in FIG. 19B. These alternatives represent menu items matching the entered characters. Each of the relevant menu items can be displayed, e.g., as a menu label containing a plurality of menu labels representing a portion of the navigational menu structure. The user can now use the up or down arrows on a keyboard, or some other input device such as a mouse, to select one of the displayed alternatives as shown in FIG. 19C. Alternatively, further search characters can be entered in the search field to refine the search.

Upon selection of the particular menu item, portions of the navigational menu structure 2640 which contain the particular menu item can then be displayed. FIG. 19 D shows an example of how the menu can be opened when an alternative is selected. Thus, a search can be performed for relevant menu items within a navigational menu structure based on certain search characters, and a plurality of such relevant menu items can be identified and displayed. Upon selection of a particular menu item from the displayed relevant menu items, a portion of the navigational menu structure can be identified and displayed which includes the particular menu item.

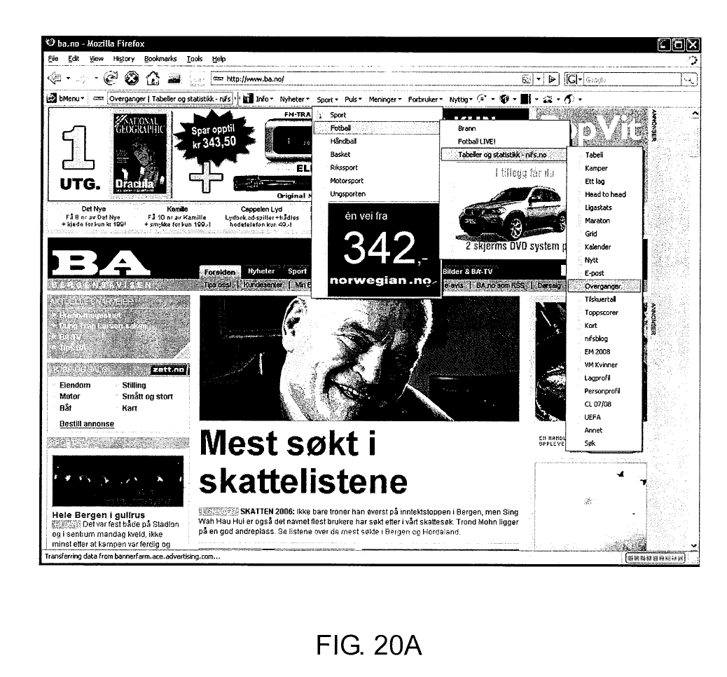

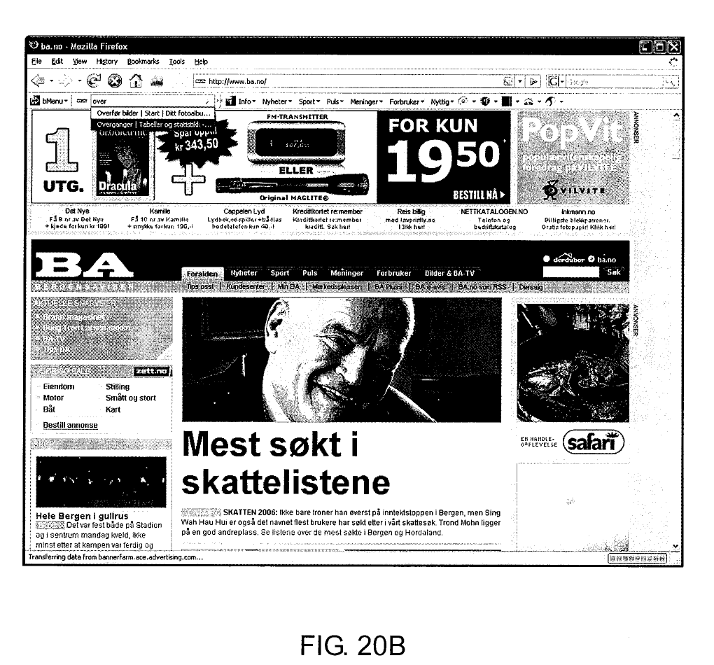

An exemplary screenshot 3600 of a menu search in accordance with exemplary embodiments of the present disclosure is shown in FIG. 20A. For example, a search term has been entered in the search field 3610, and two search results can be displayed below the search field as a drop-down menu list 3620.

FIG. 20B shows another exemplary screenshot 3650 which includes a display of menu search results in accordance with exemplary embodiments of the present disclosure. For example, a selected search result can be displayed in the search field 3610 after it is selected from the list of search results. The menu search result can then be displayed as a revealed portion 3640 of the navigational menu structure. In the exemplary results shown in FIG. 20B, the search result is located three levels below the main menu level displayed in the browser menu bar.

According to some embodiments of the disclosure, an algorithm is provided for performing what can be referred to as a fuzzy search. This algorithm can compare search terms with a spell checker library or a library of synonyms. Such an algorithm can be able to provide relevant hits even if a user misspells an entry, or if a synonym of a search term would produce a relevant hit. By way of example, if the user types “cra” the spell checker could provide hits for the word “car”, and the library of synonyms could provide hits including the word “auto”.

In certain embodiments of the disclosure, the parent categories of the hits presented in the drop down menu displayed in FIG. 19A can be shown with a different style next to the relevant menu item representing the actual hit, in order to enrich the search result. Such “parent” categories can themselves be entries in the hierarchical structure of information items at a higher hierarchical level than the item representing the hit. Parent categories can include, e.g., menu labels which are directly above the relevant menu item in a hierarchy of the navigational menu structure. For example, in FIG. 19B, the relevant menu item can include a label containing the menu label “FIFA” which was identified based on a match with the characters “fif,” together with the parent categories “Football” and “Sport.” Examples of a different style can include, but are not limited to, different typeface, different font size, different color, and different background color. This will help the user to select the most relevant search result according to the performed search. The relationship of the parent categories to the relevant menu item are shown, e.g., in the displayed menu structure in FIG. 19D.

Certain identified relevant menu items can be associated with one or more common parent categories, e.g., they can be located below a common menu item within the navigational menu structure. Such relevant menu items can be displayed in a results list together with a full list of the parent categories, or alternatively, with a truncated list of the parent categories. Truncation can be performed, e.g., by truncating each parent category or by limiting a total number of parent categories displayed with each relevant menu item. Optionally, a width of the displayed list of relevant menu items can be adjusted, e.g., widened, based on the number of parent categories displayed.

One or more searches within the menu content associated with the navigational menu structure can be performed each time one or more characters are entered in the search field. Such searches can generate and display a dynamically updated list of relevant menu items which can change as characters are entered or deleted in the search field. To avoid generation of a list of prior searches which can not be relevant, the search field can be configured to generate a list of relevant menu items only after a certain number of characters have been entered. For example, a first search in a list of prior searches can be performed after, e.g., three characters have been entered in the search field, and a further search can subsequently be performed each time an additional character is entered or removed. The search field can be configured to perform a new search when some other minimum number of characters has been entered in the search field.

A change of character sets can also be performed, e.g., in the background, when characters from a language such as Japanese are entered in the search field. For example, Japanese symbols can automatically be converted to Latin characters in the search field to perform a search for relevant menu items. Such conversion can facilitate and/or simplify searches performed in menus based on Japanese or other languages containing non-Latin characters.

Consistent with the principles of the disclosure, menu search results can be provided in a hierarchical display. The selected result from the menu list under the search field can be displayed in an opened menu structure which can display which parent categories the selected menu item belongs to.

According to an alternative embodiment, the result can be shown as a stack of cards, a series of overlapping windows, etc. This can be useful when the result is several levels down in the menu structure and the displayed menu items are overlapping because of limited screen space.

For example, a menu search for “FIFA” can identify one menu containing this word located under a parent category “Football,” which can in turn be a subcategory of a menu item “Sport,” as shown, e.g., in FIG. 19D. Both the Sport and Football menu items can be displayed at the same time as a portion of the navigational menu structure 2640. Such display can provide direct visual information of which parent category(s) the particular search result belongs under, and can further display other menu items at the same hierarchal level and/or lower levels (e.g., “children”) if the navigational menu structure is deeper. For example, a portion of the navigational menu structure containing a predetermined number of menu levels above and/or below the particular search result can be displayed. Alternatively, a portion of the navigational menu structure from a top level or some other predetermined level down to the hierarchal level containing the particular search result can be displayed. In certain exemplary embodiments of the present disclosure, particular search results which are selected can be displayed on a site map, e.g., a web page containing textual links to web pages, or to specific locations on such web pages, within the site. Such links can further be arranged in correspondence with the navigational menu structure. The search results can be displayed such that only parent categories corresponding to a particular menu item are displayed on such site map. Alternatively, search results can be displayed as a list. Such list can be preferable, e.g., on a small-screen device such as, e.g., a cell phone or a personal digital assistant.

Data describing the navigational menu structure can be stored in memory or another storage arrangement which can be local to a client (e.g., a personal computer, a cell phone, or another device which can be used to browse a website or database, and/or to initiate a menu search). Alternatively, such data can be stored in memory local to the web page or web site being navigated and/or searched, e.g., it can be stored on a server side. Access time for searches can be enhanced if such data are stored local to the client. However, the searches involving large amounts of such data can be faster if the data is stored on the server side or provide lazy loading in the background, depending on bandwidth.

The data describing the navigational menu structure can be provided as, e.g., a list containing only menu labels, or it can include metadata and/or further information relating to a menu structure of a web site or a data base, as has already been described e.g. with reference to FIGS. 8A and B with corresponding description. A file structure for such data can be stored, e.g., in XML format. Such data can include, for example, a list of menu labels together with a target URL for a web page or document corresponding to each menu label, or alternatively, an identifier which can provide information relating to an URL or a document. If the menu search is provided to access features in a software program, the data can include pointers to certain functions or software routines associated with certain menu labels.

The data describing the navigational menu structure can also include additional information relating to content on web pages or other portions of a navigable database such as, e.g., indexed documents having content which can be searchable. Thus, in certain exemplary embodiments of the present disclosure, a menu search can locate search terms, e.g., characters entered in the search field, or information relevant to such search terms, which can be located on a web page or in an indexed document. The search results can be provided in a menu or list as described herein, such as the results shown in FIG. 19B. These exemplary results can include certain menu item labels which correspond to a portion of the navigational menu structure which leads to a page or document on which the identified search term is located. Selected search results can also be displayed as a portion of the navigational menu structure, such as the menu structure shown in FIG. 19D.

Exemplary advertising system and method can also be combined with the search system and method described herein. An exemplary menu-based advertising method and system is described, e.g., in U.S. Patent Application No. 60/916,276, the entire disclosure of which is incorporated herein by reference. For example, an advertisement 3660 can be placed in the list of results together with the search results themselves. Such advertisement can be placed, e.g., at the bottom of the list of results or in any other desired location. The advertisement can also be selected for display based on, e.g., the search terms or characters entered in the search field. Such advertisements can be provided as text advertisements which can be displayed in a results list, or graphical advertisements (e.g., animated or static images) provided in formats such as, for example, flash, JPG, GIF, PNG or embedded video. Such displayed advertisements can provide brand exposure, or they can also be provided as selectable menu items which can include a link, e.g., to an advertiser's product page or website, etc. Such advertisements can also be ported from existing advertising systems such as, but not limited to, Yahoo advertising, Google Adsense, Vibrant Media, Tradedoubler or other similar advertising services. An exemplary advertisement is shown in FIG. 20B being displayed together with the navigational menu structure which corresponds to a selected menu search result.

The search field for the menu search system and method described herein can be normally hidden from view, such that it can be activated and made visible and accessible to a user in a browser or other client device by, e.g., pressing a “hot key” or combination of keys (such as, e.g., Control+M) or in response to some other input. For example, the search field can be displayed in an existing menu bar, or it can be provided in a separate browser element such as, e.g., a floating window or a new menu search bar.

The exemplary menu search method and system described herein can also be used in operating systems and software applications to locate menus. For example, typing “font” in a provided search field while using, e.g., Microsoft Word program can generate a display of opened menus in Word which show where the “font” menu is located. The search field can be integrated with an operating system or application, or it can be provided external to such operating system or application.

In certain exemplary embodiments of the present disclosure, the search results can include links to particular documents within a web site or database. Symbols can be provided with the search results to identify what type of document is associated with a search result. Such symbols can be displayed together with labels (e.g., search result list items) associated with the search results. For example, the symbols can have a form of small icons to indicate that a search result is a file such as, e.g., a Word document, an Adobe file, an Excel file, etc. Such symbols can also be icons which can indicate, e.g., how recently updated a search result document or file is, on what level in the navigational menu hierarchy the search result is arranged, etc.

The exemplary menu search system and method described herein can also be provided on other client devices such as, e.g., cell phones, car navigation units, other small screen units, game consoles (such as Microsoft Xbox, Sony PlayStation, Nintendo Wii), and television-based Internet or database navigation devices (e.g., “set-top boxes”). When performing a menu search, there can be many search results, and displayed results can optionally include parent categories and/or siblings within the navigational menu structure. However, space available for displaying such results can be limited. In certain exemplary embodiments of the present disclosure, search results can appear as generated menus, where typing into a menu search field can generate a transfer directly into a menu location, and further typing can lead to deeper menu searches in lower levels of the hierarchy as displayed search results are selected and further search terms are entered in the search field.

In further exemplary embodiments of the present disclosure, a plurality of searches can be performed based on a single search term entry in the menu search field. For example, in addition to the menu search described herein, other searches can also be performed using the same search term, such as an Internet search, a Wikipedia search, or other conventional searches. The results of these searches, including the menu search, can be displayed as described herein, e.g., as a list or a drop-down menu. For example, the displayed results can first list any menu search results, followed by a web site search result, and then results from an external search engine such as, e.g., Google. The number of the search results to display for each type of search can be predetermined or alternatively, selectable by a user.

Further, e.g., new searches can be performed on a particular search term if initial searches do not provide any results. For example, if the menu search does not identify any matches for a search term, a Google-based search can then be performed automatically. They types of searches and the order in which they are performed can also be predetermined or selected by a user. Symbols, such as icons, can also be provided as described herein to indicate what type of search was used to identify each displayed result.

From the description of the exemplary embodiments of the present disclosure provided herein, together with the figures and appended claims, a number of advantages of the present disclosure can become evident:

a) providing a searchable navigational menu in a consistent location associated with a browser or other client, a user can locate and access the menu easily, similar to the display of standard menus within a computer operating system;

b) using content detection methods described above, standard menu items can be generated that can link to specific types of content on various web sites, such as contact information, and the menu items can be searchable;

c) a standard menu interface can provide a common layout and design for navigation of any web site browsed by the user;

d) a standard menu interface can allow a user to vary the size and/or the appearance of text in menu labels to make them easier to read and to accommodate the user's preferences;

e) a multilevel or a hierarchal menu can allow the user to navigate the web site without having to browse or load the web pages that can intervene in the link structure of the web site

f) a multilevel or hierarchal menu can permit the user to search and navigate directly to a specific page of the web site, and to view the various pages available within a web site without loading them;

g) a multilevel or hierarchal menu can be provided on any web page within the web site, and allow direct search or navigation to any other page within the web site;

h) server-based translation of a multilevel or hierarchal menu can allow the user to choose the language of the menu labels associated with the web site, and to identify certain types of content on the web site in the desired language, searches can be performed in the chosen language;

i) a multilevel or hierarchal menu can be generated and stored on a server independently from the web site, likely resulting in no implementation or generation thereof on the web site;

j) a multilevel or hierarchal menu interface can provide easy search or navigation on small-screen devices such as PDA's or mobile phones;

k) a multilevel or hierarchal menu interface can provide easy search or navigation of web content on TV-based web browsers; and

l) data associated with a web page can be processed and filtered to separate page content and page links, and users can be provided with options to display only page content or menus of page links, to allow improved navigation and access to web pages, particularly on small-screen devices.

The foregoing merely illustrates the principles of the disclosure. Various modifications and alterations to the described embodiments will be apparent to those skilled in the art in view of the teachings herein. For example, web pages, page content, page links, etc., can be provided on and/or accessed via an intranet instead of or in addition to via the Internet. It will thus be appreciated that those skilled in the art will be able to devise numerous systems, arrangements and methods which, although not explicitly shown or described herein, embody the principles of the disclosure and are thus within the spirit and scope of the present disclosure. The detailed description, given by way of example, but not intended to limit the disclosure solely to the specific embodiments described, can best be understood in conjunction with the accompanying Figures.

The foregoing applications, and all publications or documents cited therein or during their prosecution (“appln. cited documents”) and all publications or documents cited or referenced in the appln. cited documents, and all publications or documents cited or referenced herein (“herein cited documents”), and all publications or documents cited or referenced in the herein cited documents, together with any manufacturer's instructions, descriptions, product specifications, or product sheets for any products mentioned herein or in any document incorporated by reference herein, are hereby incorporated herein by reference, and can be employed in the practice of the present disclosure. Citation or identification of any document in this application is not an admission that such document is available as prior art to the present disclosure.

It is noted that in this disclosure and particularly in the claims, terms such as “comprises,” “comprised,” “comprising” and the like can have the meaning attributed to them in U.S. Patent law; e.g., they can mean “includes,” “included,” “including” and the like; and that terms such as “consisting essentially of” and “consists essentially of” can have the meaning ascribed to them in U.S. patent law, e.g., they can allow for elements not explicitly recited, but can exclude elements that are found in the prior art or that can affect a basic or novel characteristic of the disclosure.

1-19. (canceled)

20. A method for performing a search in a hierarchical structure of a plurality of information items, comprising:
receiving a user input representing a search term;
using a computing arrangement, performing a search for the information items corresponding to the search term in a file, wherein the file is at least one of residing on a server or received from a server, and the is file describing a hierarchical structure of the information items, wherein the information items relate to web pages, and wherein the hierarchical structure relates to a link structure between the web pages; and
displaying at least one of the information items in at least one of a menu-based presentation or a hierarchical presentation, wherein at least one of the displayed information items is included in results obtained from the search, and wherein the presentation of the hierarchical structure of information items includes at least one parent item.

21. The method of claim 20, wherein the hierarchical structure of information items are in a form of an extensible markup language (XML) file, and the information items are included entries in the XML file.

22. The method of claim 21, wherein the entries comprise a uniform resource identifier and a title.

23. The method of claim 20, wherein the web pages reside on a first location in a computer network, and the hierarchical structure resides on a second location in the computer network.

24. The method of claim 20, wherein the plurality of information items comprise a searchable index of at least one of words or phrases contained in documents associated with the information items.

25. The method of claim 20, further comprising:
presenting at least one of the information items resulting from the search; and
receiving a further user input representing at least one selected information item from a list of the information items.

26. The method of claim 20, further comprising displaying an advertisement with the presentation of the information items.

27. A system for performing a search in a hierarchical structure of a plurality of information items, comprising:
a computer-accessible medium having executable instructions thereon, wherein when at least one computing arrangement executes the instructions, the at least one computing arrangement is configured to:
receive a user input from an input interface, wherein the user input represents a search term;
perform a search for the information items corresponding to the search term in a file, wherein the file is at least one of residing on a server or received from the server, and the file is describing a hierarchical structure of the information items, wherein the information items relate to web pages, and wherein the hierarchical structure relates to a link structure between the web pages; and
displaying, on a display, at least one of the information items in at least one of a menu-based presentation or a hierarchical presentation, wherein at least one of the displayed information items is included in results obtained from the search, and wherein the presentation of the hierarchical structure of information items includes at least one parent item.

28. The system of claim 27, wherein the hierarchical structure of information items are in a form of an extensible markup language (XML) file, and the information items are included entries in the XML file.

29. The system of claim 28, wherein the entries comprise a uniform resource identifier and a title.

30. The system of claim 27, wherein the web pages reside on a first location in a computer network, and the hierarchical structure resides on a second location in the computer network, and wherein the system further comprises:
a network interface configured to facilitate a retrieval of the web pages from the first location and the hierarchical structure from the second location.

31. The system of claim 27, wherein the plurality of information items comprise a searchable index of at least one of words or phrases contained in documents associated with the information items.

32. The system of claim 27, wherein the computing arrangement is further configured to:
present, on the display, at least one of the information items resulting from the search; and
receive a further user input, from the user input interface, representing at least one selected information item from a list of the information items.

33. The system of claim 27, wherein the computing arrangement is further configured to display an advertisement with the presentation of the information items.

34. A computer-accessible medium having stored thereon computer executable instructions for performing a search in a hierarchical structure of a plurality of information items which, when executed by a computing arrangement, configure the computing arrangement to:
receive a user input representing a search term;
perform a search for the information items corresponding to the search term in a file, wherein the file is at least one of residing on a server or received from a server, and the file is describing a hierarchical structure of the information items, wherein the information items relate to web pages, and wherein the hierarchical structure relates to a link structure between the web pages; and
display at least one of the information items in at least one of a menu-based presentation or a hierarchical presentation, wherein at least one of the displayed information items is included in the results obtained from the search, and wherein the presentation of the hierarchical structure of information items includes at least one parent item.

35. The computer-accessible medium of claim 34, wherein the hierarchical structure of information items are in a form of an extensible markup language (XML) file, and the information items are included entries in the XML file.

36. The computer-accessible medium of claim 35, wherein the entries comprise a uniform resource identifier and a title.

37. The computer-accessible medium of claim 34, wherein the web pages reside on a first location in a computer network, and the hierarchical structure resides on a second location in the computer network.

38. The computer-accessible medium of claim 34, wherein the plurality of information items comprise a searchable index of at least one of words or phrases contained in documents associated with the information items.

39. The computer-accessible medium of claim 34, wherein the computing arrangement is further configured to:
present at least one of the information items resulting from the search;
receive a further user input representing at least one selected information item from a list of the information items; and
display an advertisement with the presentation of the information items.
